(19) United States
(12) Patent Application Publication
(10) Pub. No.: US 2009/0216561 A1
(43) Pub. Date: Aug. 27, 2009

(54) METHODS FOR MANAGEMENT OF ANTICOAGULATION THERAPY

(75) Inventor: William Woo, Edmonds, WA (US)

Correspondence Address: WILSON SONSINI GOODRICH & ROSATI, 650 PAGE MILL ROAD, PALO ALTO, CA, 94304-1050, US

(73) Assignee: Swedish Health Services, Seattle, WA (US)

(21) Appl. No.: 12/390,319

(22) Filed: Feb. 20, 2009

Related U.S. Application Data
(60) Provisional application No. 61/030,873, filed on Feb. 22, 2008.

(51) Int. Cl. G06Q 50/00

(52) U.S. Cl. 705/3

(57) ABSTRACT

Presented herein are methods for determining dosages of anticoagulants for a patient. Also presented herein are apparatuses for determining dosages of anticoagulants for a patient. Further presented herein are electronic medical records systems comprising a program for determining dosages of anticoagulants for a patient. Further presented herein are clinical decision support programs for determining dosages of anticoagulants for a patient. Further presented herein are virtual anticoagulation clinics for determining dosages of anticoagulants for a patient. Further presented herein are point of care anticoagulation devices for determining dosages of anticoagulants for a patient.

### CROSS-REFERENCE

This application claims benefit of priority under 35 U.S.C. § 119(e) from provisional patent application 61/030,873, filed Feb. 22, 2008, which is incorporated herein by reference in its entirety.

### BACKGROUND OF THE INVENTION

Anticoagulants are commonly used to treat thrombotic conditions, disorders of the coagulation that result in abnormal clot formation. Because of a very complex pharmacology, anticoagulants may be difficult medications to manage. Many factors affect the anticoagulant effect, for example, genetic factors, age, sex, diet, drug interactions, and illness, as well as patient compliance with recommended dosing schedules. The use of anticoagulants is widespread. Management has usually been through traditional physician visits, anticoagulation clinics, and rarely through self-management programs. In the case of traditional physician visits, there is a wide variation in the management approach, often dependent on individual experience or local practice habits. Studies have shown that many patients are not optimally treated and these patients spend much of their time with suboptimal treatment, resulting in treatment failures or complications. A more consistent approach to management would potentially decrease the number of treatment failures and adverse events.

### SUMMARY OF THE INVENTION

Presented herein are methods for determining dosages of anticoagulants for a patient. Also presented herein are apparatuses for determining dosages of anticoagulants for a patient. Further presented herein are electronic medical records systems comprising a program for determining dosages of anticoagulants for a patient. Further presented herein are clinical decision support programs for determining dosages of anticoagulants for a patient. Further presented herein are virtual anticoagulation clinics for determining dosages of anticoagulants for a patient. Further presented herein are point of care anticoagulation devices for determining dosages of anticoagulants for a patient.

In one aspect are methods for managing a patient's anticoagulation therapy comprising: inputting (a) the patient's cumulative dose of anticoagulant from a previous time period, (b) the patient's current INR, (c) an INR target, and (d) current anticoagulant pill size, into a series of equations; determining a new dose allocated for a next time period, chosen from a preselected list of doses ranging from a minimum dose to a maximum dose for the anticoagulant pill size; and providing the new allocated dose.

In one embodiment of such methods, the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

In another embodiment of such methods, the INR target is about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

In another embodiment of such methods, the anticoagulant is warfarin. In another embodiment of such methods, the preselected list of doses corresponds to at least one mnemonic. In another embodiment of such methods, the previous time period and the next time period are one week. In another embodiment of such methods, the method further comprises inputting another anticoagulant pill size other than the current anticoagulant pill size before providing the new allocated dose. In another embodiment of such methods, the new dose is therapeutically effective. In another embodiment of such methods, the new dose is provided on a printout, by audible means, by electronic means, or any combination thereof. In another embodiment of such methods, the method further comprises inputting the patient's genetic factors, age, sex, diet, drug interactions, illness, or patient compliance with prior dosing schedules, or any combination thereof, into the series of equations.

In another aspect are apparatuses for managing a patient's anticoagulation therapy comprising: means for accepting (a) the patient's cumulative dose of anticoagulant from a previous time period, (b) the patient's current INR, (c) an INR target, and (d) current anticoagulant pill size, into a series of equations; means for determining a new dose allocated for a next time period, chosen from a preselected list of doses ranging from a minimum dose to a maximum dose for the anticoagulant pill size; and means for providing the new allocated dose.

In one embodiment of such apparatuses, the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

In another embodiment of such apparatuses, the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

In another embodiment of such apparatuses, the anticoagulant is warfarin. In another embodiment of such apparatuses, the preselected list of doses corresponds to at least one mnemonic. In another embodiment of such apparatuses, the previous time period and the next time period are one week. In another embodiment of such apparatuses, the apparatus further comprises means for accepting another anticoagulant pill size other than the current anticoagulant pill size. In another embodiment of such apparatuses, the means for providing the new allocated dose is a printout, is audible, is electronic, or any combination thereof. In another embodiment of such apparatuses, the apparatus further comprises means for accepting the patient's genetic factors, age, sex, diet, drug interactions, illness, or patient compliance with prior dosing schedules, or any combination thereof, into the series of equations.

In another aspect are electronic medical records systems comprising a program for managing a patient's anticoagulation therapy, the program comprising: means for recording (a) the patient's cumulative dose of anticoagulant from a previous time period, (b) the patient's current INR, (c) an INR target, and (d) current anticoagulant pill size; means for accepting (a)-(d) into a series of equations; means for determining a new dose allocated for a next time period, chosen from a preselected list of doses ranging from a minimum dose to a maximum dose for the anticoagulant pill size; and means for recording the new allocated dose.

In one embodiment of such electronic medical records systems, the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

In another embodiment of such electronic medical records systems, the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

In another embodiment of such electronic medical records systems, the anticoagulant is warfarin. In another embodiment of such electronic medical records systems, the preselected list of doses corresponds to at least one mnemonic. In another embodiment of such electronic medical records systems, the previous time period and the next time period are one week. In another embodiment of such electronic medical records systems, the system further comprises means for accepting another anticoagulant pill size other than the current anticoagulant pill size.

In another aspect are clinical decision support programs for managing a patient's anticoagulation therapy, the program comprising: means for accepting (a) the patient's cumulative dose of anticoagulant from a previous time period, (b) the patient's current INR, (c) an INR target, and (d) current anticoagulant pill size, into a series of equations; means for determining a new dose allocated for a next time period, chosen from a preselected list of doses ranging from a minimum dose to a maximum dose for the anticoagulant pill size; and means for providing the new allocated dose.

In one embodiment of such clinical decision support programs, the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

In another embodiment of such clinical decision support programs, the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

In another embodiment of such clinical decision support programs, the anticoagulant is warfarin. In another embodiment of such clinical decision support programs, the preselected list of doses corresponds to at least one mnemonic. In another embodiment of such clinical decision support programs, the previous time period and the next time period are one week. In another embodiment of such clinical decision support programs, the program further comprises means for accepting another anticoagulant pill size other than the current anticoagulant pill size.

In another aspect are virtual anticoagulation clinics comprising: means for accepting (a) the patient's cumulative dose of anticoagulant from a previous time period, (b) the patient's current INR, (c) an INR target, and (d) current anticoagulant pill size, into a series of equations; means for determining a new dose allocated for a next time period, chosen from a preselected list of doses ranging from a minimum dose to a maximum dose for the anticoagulant pill size; and means for providing the new allocated dose.

In one embodiment of such virtual anticoagulation clinics, the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

In another embodiment of such virtual anticoagulation clinics, the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

In another embodiment of such virtual anticoagulation clinics, the anticoagulant is warfarin. In another embodiment of such virtual anticoagulation clinics, the preselected list of doses corresponds to at least one mnemonic. In another embodiment of such virtual anticoagulation clinics, the previous time period and the next time period are one week. In another embodiment of such virtual anticoagulation clinics, the clinic further comprises accepting another anticoagulant pill size other than the current anticoagulant pill size before providing the new allocated dose.

In another aspect are point of care anticoagulation devices for management of a patient's anticoagulant therapy comprising: means for measuring the patient's current prothrombin time or INR; means for accepting (a) the patient's cumulative dose of anticoagulant from a previous time period, (b) the patient's current INR, (c) an INR target, and (d) current anticoagulant pill size, into a series of equations; means for determining a new dose allocated for a next time period, chosen from a preselected list of doses ranging from a minimum dose to a maximum dose for the anticoagulant pill size; and means for providing the new allocated dose.

In one embodiment of such anticoagulation devices, the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

In another embodiment of such anticoagulation devices, the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

In another embodiment of such anticoagulation devices, the anticoagulant is warfarin. In another embodiment of such anticoagulation devices, the preselected list of doses corresponds to at least one mnemonic. In another embodiment of such anticoagulation devices, the previous time period and the next time period are one week. In another embodiment of such anticoagulation devices, the device further comprises means for accepting another anticoagulant pill size other than the current anticoagulant pill size.

In another aspect are methods for managing a patient's warfarin therapy comprising: inputting (a) the patient's cumulative dose of warfarin from the previous week, (b) the patient's current INR, (c) an INR target, and (d) current warfarin pill size, into a series of equations; determining a new dose allocated for the next week, chosen from a preselected list of doses ranging from a minimum dose to a maximum dose for the warfarin pill size; inputting another warfarin pill size into the series of equations if desired and determining a new dose allocated for the next week chosen from a preselected list of doses ranging from a minimum dose to a maximum dose for the new warfarin pill size; and providing the new allocated dose; wherein when the INR target is from about 2.0 to about 3.0 the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

and wherein when the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

and wherein N is the new dose and C is the previous cumulative weekly dose.

### BRIEF DESCRIPTION OF THE DRAWINGS

FIG. 1 is an illustrative flow chart showing a method for management of anticoagulation therapy.

FIG. 2 is an illustrative flow chart showing data input for a method for management of anticoagulation therapy.

FIG. 3 is an illustrative flow chart showing new dose generation for an INR target of 2.0 to 3.0.

FIG. 4 is an illustrative flow chart of an Allocation Generator.

FIG. 5 is an illustrative screenshot of an application user interface of a method for management of anticoagulation therapy.

FIG. 6 is an illustrative example of a patient printout.

### DETAILED DESCRIPTION OF THE INVENTION

The appended claims particularly point out features of the invention set forth herein. A better understanding of the features and advantages of the present disclosure will be obtained by reference to the following description that sets forth illustrative embodiments, in which the principles described herein are utilized.

Anticoagulants are used to manage many clinical conditions that are the result of abnormal clot formation, or are associated with an increased propensity for abnormal clotting. These include atrial fibrillation, deep venous thromboses, pulmonary emboli, and congenital and acquired hypercoagulable states. Treatment of these states with anticoagulation therapy will decrease recurrences or progression of disease.

The term “anticoagulant” as used herein includes, but is not limited to, warfarin, Coumadin, warfarin sodium salt, warfarin derivatives, Coumadin derivatives, dicumarol, all vitamin K antagonists, all substances derived from and/or related to the foregoing substances, and any combination thereof.

Hemostasis, the process of blood coagulation involves a sequence of reactions that culminate in the formation of a clot. After an injury, the formation of clots is extremely important for survival, but in other conditions clot formation results in a disease state. Anticoagulant medications directly affect coagulation reactions, thus decreasing the potential for clot formation. For example, warfarin, a commonly used anticoagulant, exerts its antithrombotic effects by antagonizing vitamin K metabolism. Vitamin K is an essential factor in the synthesis of many coagulations factors, including Factors II, VII, IX, X, protein C and Protein S. It is absorbed in the stomach and small intestines and then is metabolized by cytochrome P-450 system isoenzymes, which reside in the liver. Many drugs are processed by the P-450 enzyme system and their presence profoundly affects warfarin metabolism. This, in turn, can affect the synthesis of the vitamin K dependent clotting factors.

The Vitamin K dependent clotting factors are involved in the extrinsic pathway, one of two major pathways for blood clot formation. The prothrombin time is the laboratory test used to assess the clotting activity of the extrinsic coagulation pathway. In the past, there was wide variation in the results of the test due to variability of the testing reagent, thromboplastin. To decrease this variation, the values are now normalized, with the test being expressed as an international normalized ratio (INR).

There is consensus regarding the optimal intensity of anticoagulation for hypercoagulable conditions. Goals for optimal INR values have been established. An INR target of 2.0 to 3.0 is recommended for the management of atrial fibrillation, pulmonary emboli, deep venous thromboses, and most hypercoagulable states. For the treatment of prosthetic heart valves or failures of less intensive treatment regimens, the recommended INR target is between 2.5 and 3.5.

Some studies show that up to 40% of patients who are chronically anticoagulated do not have INR levels at their target ranges. Thrombotic events increase at INRs less than 2.0 and bleeding complications increase at INRs greater than 4.5. Multiple factors come into play. These include drug interactions, acute illnesses that either affects the liver or the kidneys, noncompliance, and management by the clinician. Experience in anticoagulation management varies widely and thus outcomes are affected.

One way to assist in keeping patients in the therapeutic anticoagulant range is to have consistent dosing protocols. This would potentially decrease the variability and allow the patients to be in the therapeutic range for a longer time. Consistent dosing protocols may also result in more clinical efficacy with fewer complications. Obtaining optimal clinical results with anticoagulants depends on achieving therapeutic anticoagulation levels.

While some protocols for anticoagulant dose management can adjust a dose, such methods do not allocate the doses over a time period for optimal use. These systems fall short in that they rely on one dose, and they do not allocate doses over a time period.

### Methods for Management of Anticoagulant Therapy

Disclosed herein are methods for determining dosage of an anticoagulant for a time period. Disclosed herein are methods that can predict anticoagulant dose changes depending on the INR readings and previous intake of the anticoagulant. The methods can also allocate the dosing of medication over a time period to enhance compliance by changing doses according to familiar mnemonics. The methods also adjust doses more aggressively in patients in whom the intensity of treatment is farther out of range.

The methods described herein include the steps of, for example, inputting (a) the patient's cumulative dose of anticoagulant from a previous time period, (b) the patient's current INR, (c) an INR target, and (d) current anticoagulant pill size, into a series of equations; determining a new dose allocated for a next time period, chosen from a preselected list of doses ranging from a minimum dose to a maximum dose for the anticoagulant pill size, and providing the new allocated dose.

The anticoagulant may be any of the anticoagulants listed herein, or a combination of more than one anticoagulant. Preferably, the anticoagulant is warfarin or a warfarin derivative. The cumulative dose of anticoagulant may be calculated by, e.g., the total amount of anticoagulant taken over the previous time period, the sum of the amount of anticoagulant taken daily over the previous time period, or any other calculation that can be used to determine the patient's total anticoagulant intake over the previous time period. The previous time period from which a patient's cumulative dose is determined may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. Preferably, the time period is 1 week. The patient's current INR is, for example, the INR of the patient taken within approximately a 24 hour time period. An INR target may be from about 2.0 and about 3.0, about 2.1 and about 3.1, about 2.2 and about 3.2, about 2.3 and about 3.3, about 2.4 and about 3.4, between about 2.5 and about 3.5, between about 2.0 and about 4.0, or any other INR target between about 2.0 and about 4.0. The patient's current anticoagulant pill size is the pill size of anticoagulant that the patient is currently taking, or, alternatively, it may be any other pill size of anticoagulant. Other data points may be inputted into the series of equations, such as a patient's genetic factors, age, sex, diet, drug interactions, illness, and/or compliance with recommended dosing schedules, or any other information that may affect a patient's response to anticoagulant therapy.

The series of equations into which the above data is entered may be any set of mathematical calculations designed to calculate a new dose of anticoagulant allocated for a next time period based on the patient's cumulative dose of anticoagulant from a previous time period. For example, for an INR target of 2.0 to 3.0, the series of equations may take the form of equations as illustrated in Table 1. For an INR target of 2.5 to 3.5, the series of equations may take the form of equations as illustrated in Table 2.

TABLE 1
INR Target of 2.0 to 3.0

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

N = new dose
C = previous cumulative weekly dose

TABLE 2
INR Target of 2.5 to 3.5

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

N = new dose
C = previous cumalative weekly dose

The methods as described herein may further determine a new dose allocated for a next time period chosen from a preselected list of doses ranging from a minimum dose to a maximum dose for the anticoagulant pill size, based on the output calculated from the series of equations. The allocated dose is expressed as a dose spread out over a time period. As a non limiting example, an allocated dose may be a daily dose given over a time period greater than one day. The next time period for which a new dose is allocated may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. The time period may be the same or different from the previous time period. Preferably, the time period is 1 week. The new dose may be allocated for the next time period chosen from a preselected list of doses ranging from a minimum dose to a maximum dose for the anticoagulant pill size. The anticoagulant pill size can be any commercially available pill size of anticoagulant or any other size of pill, e.g., 1 mg, 2 mg, 5 mg, or 7.5 mg. Preferably, when warfarin is the anticoagulant, the pill sizes used are 1 mg, 2 mg, 2.5 mg, 3 mg, 4 mg, 5 mg, 6 mg, 7.5 mg, and/or 10 mg. For example, the minimum and maximum doses of several anticoagulant pill sizes are shown in Table 3.

TABLE 3
Maximum and minimum doses per week of anticoagulant pill sizes

| | Pill Size | | | | | | | | |
|---|---|---|---|---|---|---|---|---|---|
| | 1 mg | 2 mg | 2.5 mg | 3 mg | 4 mg | 5 mg | 6 mg | 7.5 mg | 10 mg |
| Minimum | 0.5 mg | 1 mg | 1.25 mg | 1.5 mg | 2 mg | 2.5 mg | 3 mg | 3.75 mg | 5 mg |
| Dose | | | | | | | | | |
| Maximum | 14 mg | 28 mg | 35 mg | 42 mg | 56 mg | 70 mg | 84 mg | 105 mg | 140 mg |
| Dose | | | | | | | | | |

Using the pill sizes, dosing ranges of the pill sizes, allocation patterns such as those described in Table 4 can be used to create a preselected list of doses ranging from a minimum dose to a maximum dose for the anticoagulant pill size. An allocation pattern may consist of a dose every day for the time period, or a pattern of alternating doses. Doses may be allocated on one or more days of the next time period. The dose may vary from one day to another. A daily dose may be ½ pill, 1 pill, 1½ pills, 2 pills or other specific dose. As a non-limiting example, the new dose may be allocated in any of the mnemonic patterns shown in Table 4, with an “X” indicating a first dose and an “O” indicating a second dose.

TABLE 4
Allocation Patterns

| | | Tues- | Wednes- | Thurs- | Fri- | Satur- | Sun- |
|---|---|---|---|---|---|---|---|
| | Monday | day | day | day | day | day | day |
| A (7 + 0) | X | X | X | X | X | X | X |
| B (6 + 1) | X | X | X | X | X | X | ◯ |
| C (3 + 4) | X | ◯ | X | ◯ | X | ◯ | ◯ |
| D (5 + 2) | ◯ | X | X | ◯ | X | X | X |

X = Dose 1
◯ = Dose 2

The preselected list of doses may also correspond to at least one mnemonic, e.g., a simple and/or repetitive pattern. The mnemonic may be simple to remember and may assist a patient in complying with the dosage schedule. For example, a mnemonic may be 7+0, 6+1, 3+4, 5+2, etc. As a non-limiting example, a preselected list of doses for several anticoagulant pill sizes ranging from a minimum dose to a maximum dose may be generated as shown in Tables 5-13.

Alternatively, the new dose may comprise two or more pill sizes of anticoagulant. For example, a dual dose protocol which uses two pill sizes of anticoagulant to arrive at the final dose may also be used in the present invention. One of the pill sizes can serve as a base dose and the other pill size can serve as a variable dose. For example, a dual dose protocol may use a 2 mg tablet and a 5 mg tablet of warfarin. As a non-limiting example, a preselected list of doses for several anticoagulant pill sizes using a dual dose protocol ranging from a minimum dose to a maximum dose may be generated as shown in Tables 14a-22i.

TABLE 5
Dose Allocation Schedule, 1 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 0.5 | 1 + 6 | B | O | 0 | 0 | 0 | 0 | 0 | half |
| 1 | 2 + 5 | D | half | 0 | 0 | half | 0 | 0 | 0 |
| 1.5 | 3 + 4 | C | half | 0 | half | 0 | half | 0 | 0 |
| 2 | 4 + 3 | C | 0 | half | 0 | half | 0 | half | half |
| 2.5 | 5 + 2 | D | 0 | half | half | 0 | half | half | half |
| 3 | 6 + 1 | B | half | half | half | half | half | half | 0 |
| 3.5 | 7 + 0 | A | half | half | half | half | half | half | half |
| 4 | 1 + 6 | B | half | half | half | half | half | half | whole |
| 4.5 | 2 + 5 | D | whole | half | half | whole | half | half | half |
| 5 | 3 + 4 | C | whole | half | whole | half | whole | half | half |
| 5.5 | 4 + 3 | C | half | whole | half | whole | half | whole | half |
| 6 | 5 + 2 | D | half | whole | whole | half | whole | whole | whole |
| 6.5 | 6 + 1 | B | whole | whole | whole | whole | whole | whole | half |
| 7 | 7 + 0 | A | whole | whole | whole | whole | whole | whole | whole |
| 7.5 | 1 + 6 | B | whole | whole | whole | whole | whole | whole | one + |
| | | | | | | | | | half |
| 8 | 2 + 5 | D | one + half | whole | whole | one + | whole | whole | 1 |
| | | | | | | half | | | |
| 8.5 | 3 + 4 | C | one + half | whole | one + | whole | one + | whole | whole |
| | | | | | half | | half | | |
| 9 | 4 + 3 | C | whole | one + | whole | one + | whole | one + | one + |
| | | | | half | | half | | half | half |
| 9.5 | 5 + 2 | D | whole | one + | one + | whole | one + | one + | one + |
| | | | | half | half | | half | half | half |
| 10 | 6 + 1 | B | one + half | one + | one + | one + | one + | one + | whole |
| | | | | half | half | half | half | half | |
| 10.5 | 7 + 0 | A | one + half | one + | one + | one + | one + | one + | one + |
| | | | | half | half | half | half | half | half |
| 11 | 1 + 6 | B | one + half | one + | one + | one + | one + | one + | two |
| | | | | half | half | half | half | half | |
| 11.5 | 2 + 5 | D | two | one + | one + | two | one + | one + | one + |
| | | | | half | half | | half | half | half |
| 12 | 3 + 4 | C | two | one + | two | one + | two | one + | one + |
| | | | | half | | half | | half | half |
| 12.5 | 4 + 3 | C | one + half | two | one + | two | one + | two | two |
| | | | | | half | | half | | |
| 13 | 5 + 2 | D | one + half | two | two | one + | two | two | two |
| | | | | | | half | | | |
| 13.5 | 6 + 1 | B | two | two | two | two | two | two | one + |
| | | | | | | | | | half |
| 14 | 7 + 0 | A | two | Two | two | two | two | two | two |

0 = no dose
half = 0.5 mg
whole = 1 mg
one + half = 1.5 mg
two = 2 mg

TABLE 6
Dose Allocation Schedule, 2 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 1 | 1 + 6 | B | O | 0 | 0 | 0 | 0 | 0 | half |
| 2 | 2 + 5 | D | Half | 0 | 0 | half | 0 | 0 | 0 |
| 3 | 3 + 4 | C | Half | 0 | half | 0 | half | 0 | 0 |
| 4 | 4 + 3 | C | 0 | half | 0 | half | 0 | half | half |
| 5 | 5 + 2 | D | 0 | half | half | 0 | half | half | half |
| 6 | 6 + 1 | B | Half | half | half | half | half | half | 0 |
| 7 | 7 + 0 | A | Half | half | half | half | half | half | half |
| 8 | 1 + 6 | B | half | half | half | half | half | half | whole |
| 9 | 2 + 5 | D | whole | half | half | whole | half | half | half |
| 10 | 3 + 4 | C | whole | half | whole | half | whole | half | half |
| 11 | 4 + 3 | C | half | whole | half | whole | half | whole | half |
| 12 | 5 + 2 | D | half | whole | whole | half | whole | whole | whole |
| 13 | 6 + 1 | B | whole | whole | whole | whole | whole | whole | half |
| 14 | 7 + 0 | A | whole | whole | whole | whole | whole | whole | whole |
| 15 | 1 + 6 | B | whole | whole | whole | whole | whole | whole | one + |
| | | | | | | | | | half |
| 16 | 2 + 5 | D | one + half | whole | whole | one + | whole | whole | 1 |
| | | | | | | half | | | |
| 17 | 3 + 4 | C | one + half | whole | one + | whole | one + | whole | whole |
| | | | | | half | | half | | |
| 18 | 4 + 3 | C | whole | one + | whole | one + | whole | one + | one + |
| | | | | half | | half | | half | half |
| 19 | 5 + 2 | D | whole | one + | one + | whole | one + | one + | one + |
| | | | | half | half | | half | half | half |
| 20 | 6 + 1 | B | one + half | one + | one + | one + | one + | one + | whole |
| | | | | half | half | half | half | half | |
| 21 | 7 + 0 | A | one + half | one + | one + | one + | one + | one + | one + |
| | | | | half | half | half | half | half | half |
| 22 | 1 + 6 | B | one + half | one + | one + | one + | one + | one + | two |
| | | | | half | half | half | half | half | |
| 23 | 2 + 5 | D | two | one + | one + | two | one + | one + | one + |
| | | | | half | half | | half | half | half |
| 24 | 3 + 4 | C | two | one + | two | one + | two | one + | one + |
| | | | | half | | half | | half | half |
| 25 | 4 + 3 | C | one + half | two | one + | two | one + | two | two |
| | | | | | half | | half | | |
| 26 | 5 + 2 | D | one + half | two | two | one + | two | two | two |
| | | | | | | half | | | |
| 27 | 6 + 1 | B | two | two | two | two | two | two | one + |
| | | | | | | | | | half |
| 28 | 7 + 0 | A | two | two | two | two | two | two | two |

0 = no dose
half = 1 mg
whole = 2 mg
one + half = 3 mg
two = 4 mg

TABLE 7
Dose Allocation Schedule, 2.5 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 5 | 6 + 1 | B | O | 0 | 0 | 0 | 0 | 0 | half |
| 10 | 2 + 5 | D | half | 0 | 0 | half | 0 | 0 | 0 |
| 15 | 3 + 4 | C | half | 0 | half | 0 | half | 0 | 0 |
| 20 | 4 + 3 | C | 0 | half | 0 | half | 0 | half | half |
| 25 | 5 + 2 | D | 0 | half | half | 0 | half | half | half |
| 30 | 6 + 1 | B | half | half | half | half | half | half | 0 |
| 35 | 7 + 0 | A | half | half | half | half | half | half | half |
| 40 | 1 + 6 | B | half | half | half | half | half | half | whole |
| 45 | 2 + 5 | D | whole | half | half | whole | half | half | half |
| 50 | 3 + 4 | C | whole | half | whole | half | whole | half | half |
| 55 | 4 + 3 | C | half | whole | half | whole | half | whole | half |
| 60 | 5 + 2 | D | half | whole | whole | half | whole | whole | whole |
| 65 | 6 + 1 | B | whole | whole | whole | whole | whole | whole | half |
| 70 | 7 + 0 | A | whole | whole | whole | whole | whole | whole | whole |
| 75 | 1 + 6 | B | whole | whole | whole | whole | whole | whole | one + |
| | | | | | | | | | half |
| 80 | 2 + 5 | D | one + half | whole | whole | one + | whole | whole | 1 |
| | | | | | | half | | | |
| 85 | 3 + 4 | C | one + half | whole | one + | whole | one + | whole | whole |
| | | | | | half | | half | | |
| 90 | 4 + 3 | C | whole | one + | whole | one + | whole | one + | one + |
| | | | | half | | half | | half | half |
| 95 | 5 + 2 | D | whole | one + | one + | whole | one + | one + | one + |
| | | | | half | half | | half | half | half |
| 100 | 6 + 1 | B | one + half | one + | one + | one + | one + | one + | whole |
| | | | | half | half | half | half | half | |
| 105 | 7 + 0 | A | one + half | one + | one + | one + | one + | one + | one + |
| | | | | half | half | half | half | half | half |
| 110 | 1 + 6 | B | one + half | one + | one + | one + | one + | one + | two |
| | | | | half | half | half | half | half | |
| 115 | 2 + 5 | D | two | one + | one + | two | one + | one + | one + |
| | | | | half | half | | half | half | half |
| 120 | 3 + 4 | C | two | one + | two | one + | two | one + | one + |
| | | | | half | | half | | half | half |
| 125 | 4 + 3 | C | one + half | two | one + | two | one + | two | two |
| | | | | | half | | half | | |
| 130 | 5 + 2 | D | one + half | two | two | one + | two | two | two |
| | | | | | | half | | | |
| 135 | 6 + 1 | B | two | two | two | two | two | two | one + |
| | | | | | | | | | half |
| 140 | 7 + 0 | A | two | two | two | two | two | two | two |

0 = no dose
half = 1.25 mg
whole = 2.5 mg
one + half = 3.75 mg
two = 5 mg

TABLE 8
Dose Allocation Schedule, 3 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 3.75 | 6 + 1 | B | O | 0 | 0 | 0 | 0 | 0 | half |
| 7.5 | 2 + 5 | D | half | 0 | 0 | half | 0 | 0 | 0 |
| 11.25 | 3 + 4 | C | half | 0 | half | 0 | half | 0 | 0 |
| 15 | 4 + 3 | C | 0 | half | 0 | half | 0 | half | half |
| 18.75 | 5 + 2 | D | 0 | half | half | 0 | half | half | half |
| 22.5 | 6 + 1 | B | half | half | half | half | half | half | 0 |
| 26.25 | 7 + 0 | A | half | half | half | half | half | half | half |
| 30 | 1 + 6 | B | half | half | half | half | half | half | whole |
| 33.75 | 2 + 5 | D | whole | half | half | whole | half | half | half |
| 37.5 | 3 + 4 | C | whole | half | whole | half | whole | half | half |
| 41.25 | 4 + 3 | C | half | whole | half | whole | half | whole | half |
| 45 | 5 + 2 | D | half | whole | whole | half | whole | whole | whole |
| 48.75 | 6 + 1 | B | whole | whole | whole | whole | whole | whole | half |
| 52.5 | 7 + 0 | A | whole | whole | whole | whole | whole | whole | whole |
| 56.25 | 1 + 6 | B | whole | whole | whole | whole | whole | whole | one + |
| | | | | | | | | | half |
| 60 | 2 + 5 | D | one + half | whole | whole | one + | whole | whole | 1 |
| | | | | | | half | | | |
| 63.75 | 3 + 4 | C | one + half | whole | one + | whole | one + | whole | whole |
| | | | | | half | | half | | |
| 67.5 | 4 + 3 | C | whole | one + | whole | one + | whole | one + | one + |
| | | | | half | | half | | half | half |
| 71.25 | 5 + 2 | D | whole | one + | one + | whole | one + | one + | one + |
| | | | | half | half | | half | half | half |
| 75 | 6 + 1 | B | one + half | one + | one + | one + | one + | one + | whole |
| | | | | half | half | half | half | half | |
| 78.75 | 7 + 0 | A | one + half | one + | one + | one + | one + | one + | one + |
| | | | | half | half | half | half | half | half |
| 82.5 | 1 + 6 | B | one + half | one + | one + | one + | one + | one + | two |
| | | | | half | half | half | half | half | |
| 86.25 | 2 + 5 | D | two | one + | one + | two | one + | one + | one + |
| | | | | half | half | | half | half | half |
| 90 | 3 + 4 | C | two | one + | two | one + | two | one + | one + |
| | | | | half | | half | | half | half |
| 93.75 | 4 + 3 | C | one + half | two | one + | two | one + | two | two |
| | | | | | half | | half | | |
| 97.5 | 5 + 2 | D | one + half | two | two | one + | two | two | two |
| | | | | | | half | | | |
| 101.25 | 6 + 1 | B | two | two | two | two | two | two | one + |
| | | | | | | | | | half |
| 105 | 7 + 0 | A | two | two | two | two | two | two | two |

0 = no dose
half = 1.5 mg
whole = 3 mg
one + half = 4.5 mg
two = 6 mg

TABLE 9
Dose Allocation Schedule, 4 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 3 | 6 + 1 | B | O | 0 | 0 | 0 | 0 | 0 | half |
| 6 | 2 + 5 | D | half | 0 | 0 | half | 0 | 0 | 0 |
| 9 | 3 + 4 | C | half | 0 | half | 0 | half | 0 | 0 |
| 12 | 4 + 3 | C | 0 | half | 0 | half | 0 | half | half |
| 15 | 5 + 2 | D | 0 | half | half | 0 | half | half | half |
| 18 | 6 + 1 | B | half | half | half | half | half | half | 0 |
| 21 | 7 + 0 | A | half | half | half | half | half | half | half |
| 24 | 1 + 6 | B | half | half | half | half | half | half | whole |
| 27 | 2 + 5 | D | whole | half | half | whole | half | half | half |
| 30 | 3 + 4 | C | whole | half | whole | half | whole | half | half |
| 33 | 4 + 3 | C | half | whole | half | whole | half | whole | half |
| 36 | 5 + 2 | D | half | whole | whole | half | whole | whole | whole |
| 39 | 6 + 1 | B | whole | whole | whole | whole | whole | whole | half |
| 42 | 7 + 0 | A | whole | whole | whole | whole | whole | whole | whole |
| 45 | 1 + 6 | B | whole | whole | whole | whole | whole | whole | one + |
| | | | | | | | | | half |
| 48 | 2 + 5 | D | one + half | whole | whole | one + | whole | whole | 1 |
| | | | | | | half | | | |
| 51 | 3 + 4 | C | one + half | whole | one + | whole | one + | whole | whole |
| | | | | | half | | half | | |
| 54 | 4 + 3 | C | whole | one + half | whole | one + | whole | one + | one + |
| | | | | | | half | | half | half |
| 57 | 5 + 2 | D | whole | one + half | one + | whole | one + | one + | one + |
| | | | | | half | | half | half | half |
| 60 | 6 + 1 | B | one + half | one + half | one + | one + | one + | one + | whole |
| | | | | | half | half | half | half | |
| 63 | 7 + 0 | A | one + half | one + half | one + | one + | one + | one + | one + |
| | | | | | half | half | half | half | half |
| 66 | 1 + 6 | B | one + half | one + half | one + | one + | one + | one + | two |
| | | | | | half | half | half | half | |
| 69 | 2 + 5 | D | two | one + half | one + | two | one + | one + | one + |
| | | | | | half | | half | half | half |
| 72 | 3 + 4 | C | two | one + half | two | one + | two | one + | one + |
| | | | | | | half | | half | half |
| 75 | 4 + 3 | C | one + half | two | one + | two | one + | two | two |
| | | | | | half | | half | | |
| 78 | 5 + 2 | D | one + half | two | two | one + | two | two | two |
| | | | | | | half | | | |
| 81 | 6 + 1 | B | two | two | two | two | two | two | one + |
| | | | | | | | | | half |
| 84 | 7 + 0 | A | two | two | two | two | two | two | two |

0 = no dose
half = 2 mg
whole = 4 mg
one + half = 6 mg
two = 8 mg

TABLE 10
Dose Allocation Schedule, 5 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 2.5 | 6 + 1 | B | O | 0 | 0 | 0 | 0 | 0 | half |
| 5 | 2 + 5 | D | half | 0 | 0 | half | 0 | 0 | 0 |
| 7.5 | 3 + 4 | C | half | 0 | half | 0 | half | 0 | 0 |
| 10 | 4 + 3 | C | 0 | half | 0 | half | 0 | half | half |
| 12.5 | 5 + 2 | D | 0 | half | half | 0 | half | half | half |
| 15 | 6 + 1 | B | half | half | half | half | half | half | 0 |
| 17.5 | 7 + 0 | A | half | half | half | half | half | half | half |
| 20 | 1 + 6 | B | half | half | half | half | half | half | whole |
| 22.5 | 2 + 5 | D | whole | half | half | whole | half | half | half |
| 25 | 3 + 4 | C | whole | half | whole | half | whole | half | half |
| 27.5 | 4 + 3 | C | half | whole | half | whole | half | whole | half |
| 30 | 5 + 2 | D | half | whole | whole | half | whole | whole | whole |
| 32.5 | 6 + 1 | B | whole | whole | whole | whole | whole | whole | half |
| 35 | 7 + 0 | A | whole | whole | whole | whole | whole | whole | whole |
| 37.5 | 1 + 6 | B | whole | whole | whole | whole | whole | whole | one + |
| | | | | | | | | | half |
| 40 | 2 + 5 | D | one + half | whole | whole | one + | whole | whole | 1 |
| | | | | | | half | | | |
| 42.5 | 3 + 4 | C | one + half | whole | one + | whole | one + | whole | whole |
| | | | | | half | | half | | |
| 45 | 4 + 3 | C | whole | one + half | whole | one + | whole | one + | one + |
| | | | | | | half | | half | half |
| 47.5 | 5 + 2 | D | whole | one + half | one + | whole | one + | one + | one + |
| | | | | | half | | half | half | half |
| 50 | 6 + 1 | B | one + half | one + half | one + | one + | one + | one + | whole |
| | | | | | half | half | half | half | |
| 52.5 | 7 + 0 | A | one + half | one + half | one + | one + | one + | one + | one + |
| | | | | | half | half | half | half | half |
| 55 | 1 + 6 | B | one + half | one + half | one + | one + | one + | one + | two |
| | | | | | half | half | half | half | |
| 57.5 | 2 + 5 | D | two | one + half | one + | two | one + | one + | one + |
| | | | | | half | | half | half | half |
| 60 | 3 + 4 | C | two | one + half | two | one + | two | one + | one + |
| | | | | | | half | | half | half |
| 62.5 | 4 + 3 | C | one + half | two | one + | two | one + | two | two |
| | | | | | half | | half | | |
| 65 | 5 + 2 | D | one + half | two | two | one + | two | two | two |
| | | | | | | half | | | |
| 67.5 | 6 + 1 | B | two | two | two | two | two | two | one + |
| | | | | | | | | | half |
| 70 | 7 + 0 | A | two | two | two | two | two | two | two |

0 = no dose
half = 2.5 mg
whole = 5 mg
one + half = 7.5 mg
two = 10 mg

TABLE 11
Dose Allocation Schedule, 6 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 2 | 6 + 1 | B | O | 0 | 0 | 0 | 0 | 0 | half |
| 4 | 2 + 5 | D | half | 0 | 0 | half | 0 | 0 | 0 |
| 6 | 3 + 4 | C | half | 0 | half | 0 | half | 0 | 0 |
| 8 | 4 + 3 | C | 0 | half | 0 | half | 0 | half | half |
| 10 | 5 + 2 | D | 0 | half | half | 0 | half | half | half |
| 12 | 6 + 1 | B | half | half | half | half | half | half | 0 |
| 14 | 7 + 0 | A | half | half | half | half | half | half | half |
| 16 | 1 + 6 | B | half | half | half | half | half | half | whole |
| 18 | 2 + 5 | D | whole | half | half | whole | half | half | half |
| 20 | 3 + 4 | C | whole | half | whole | half | whole | half | half |
| 22 | 4 + 3 | C | half | whole | half | whole | half | whole | half |
| 24 | 5 + 2 | D | half | whole | whole | half | whole | whole | whole |
| 26 | 6 + 1 | B | whole | whole | whole | whole | whole | whole | half |
| 28 | 7 + 0 | A | whole | whole | whole | whole | whole | whole | whole |
| 30 | 1 + 6 | B | whole | whole | whole | whole | whole | whole | one + |
| | | | | | | | | | half |
| 32 | 2 + 5 | D | one + half | whole | whole | one + | whole | whole | 1 |
| | | | | | | half | | | |
| 34 | 3 + 4 | C | one + half | whole | one + | whole | one + | whole | whole |
| | | | | | half | | half | | |
| 36 | 4 + 3 | C | whole | one + | whole | one + | whole | one + | one + |
| | | | | half | | half | | half | half |
| 38 | 5 + 2 | D | whole | one + | one + | whole | one + | one + | one + |
| | | | | half | half | | half | half | half |
| 40 | 6 + 1 | B | one + half | one + | one + | one + | one + | one + | whole |
| | | | | half | half | half | half | half | |
| 42 | 7 + 0 | A | one + half | one + | one + | one + | one + | one + | one + |
| | | | | half | half | half | half | half | half |
| 44 | 1 + 6 | B | one + half | one + | one + | one + | one + | one + | two |
| | | | | half | half | half | half | half | |
| 46 | 2 + 5 | D | two | one + | one + | two | one + | one + | one + |
| | | | | half | half | | half | half | half |
| 48 | 3 + 4 | C | two | one + | two | one + | two | one + | one + |
| | | | | half | | half | | half | half |
| 50 | 4 + 3 | C | one + half | two | one + | two | one + | two | two |
| | | | | | half | | half | | |
| 52 | 5 + 2 | D | one + half | two | two | one + | two | two | two |
| | | | | | | half | | | |
| 54 | 6 + 1 | B | two | two | two | two | two | two | one + |
| | | | | | | | | | half |
| 56 | 7 + 0 | A | two | two | two | two | two | two | two |

0 = no dose
half = 3 mg
whole = 6 mg
one + half = 9 mg
two = 12 mg

TABLE 12
Dose Allocation Schedule, 7.5 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 1.5 | 6 + 1 | B | O | 0 | 0 | 0 | 0 | 0 | half |
| 3 | 2 + 5 | D | half | 0 | 0 | half | 0 | 0 | 0 |
| 4.5 | 3 + 4 | C | half | 0 | half | 0 | half | 0 | 0 |
| 6 | 4 + 3 | C | 0 | half | 0 | half | 0 | half | half |
| 7.5 | 5 + 2 | D | 0 | half | half | 0 | half | half | half |
| 9 | 6 + 1 | B | half | half | half | half | half | half | 0 |
| 10.5 | 7 + 0 | A | half | half | half | half | half | half | half |
| 12 | 1 + 6 | B | half | half | half | half | half | half | whole |
| 13.5 | 2 + 5 | D | whole | half | half | whole | half | half | half |
| 15 | 3 + 4 | C | whole | half | whole | half | whole | half | half |
| 16.5 | 4 + 3 | C | half | whole | half | whole | half | whole | half |
| 18 | 5 + 2 | D | half | whole | whole | half | whole | whole | whole |
| 19.5 | 6 + 1 | B | whole | whole | whole | whole | whole | whole | half |
| 21 | 7 + 0 | A | whole | whole | whole | whole | whole | whole | whole |
| 22.5 | 1 + 6 | B | whole | whole | whole | whole | whole | whole | one + |
| | | | | | | | | | half |
| 24 | 2 + 5 | D | one + half | whole | whole | one + | whole | whole | 1 |
| | | | | | | half | | | |
| 25.5 | 3 + 4 | C | one + half | whole | one + | whole | one + | whole | whole |
| | | | | | half | | half | | |
| 27 | 4 + 3 | C | whole | one + | whole | one + | whole | one + | one + |
| | | | | half | | half | | half | half |
| 28.5 | 5 + 2 | D | whole | one + | one + | whole | one + | one + | one + |
| | | | | half | half | | half | half | half |
| 30 | 6 + 1 | B | one + half | one + | one + | one + | one + | one + | whole |
| | | | | half | half | half | half | half | |
| 31.5 | 7 + 0 | A | one + half | one + | one + | one + | one + | one + | one + |
| | | | | half | half | half | half | half | half |
| 33 | 1 + 6 | B | one + half | one + | one + | one + | one + | one + | two |
| | | | | half | half | half | half | half | |
| 34.5 | 2 + 5 | D | two | one + | one + | two | one + | one + | one + |
| | | | | half | half | | half | half | half |
| 36 | 3 + 4 | C | two | one + | two | one + | two | one + | one + |
| | | | | half | | half | | half | half |
| 37.5 | 4 + 3 | C | one + half | two | one + | two | one + | two | two |
| | | | | | half | | half | | |
| 39 | 5 + 2 | D | one + half | two | two | one + | two | two | two |
| | | | | | | half | | | |
| 40.5 | 6 + 1 | B | two | two | two | two | two | two | one + |
| | | | | | | | | | half |
| 42 | 7 + 0 | A | two | two | two | two | two | two | two |

0 = no dose
half = 3.75 mg
whole = 7.5 mg
one + half = 11.25 mg
two = 15 mg

TABLE 13
Dose Allocation Schedule, 10 mg pill

| Weekly | | | Number of pills | | | | | | |
|---|---|---|---|---|---|---|---|---|---|
| dose (mg) | Allocation | Protocol | M | Tu | We | Th | F | Sa | Su |
| 1.25 | 1 + 6 | B | O | 0 | 0 | 0 | 0 | 0 | half |
| 2.5 | 2 + 5 | D | half | 0 | 0 | half | 0 | 0 | 0 |
| 3.75 | 3 + 4 | C | half | 0 | half | 0 | half | 0 | 0 |
| 5 | 4 + 3 | C | 0 | half | 0 | half | 0 | half | half |
| 6.25 | 5 + 2 | D | 0 | half | half | 0 | half | half | half |
| 7.5 | 6 + 1 | B | half | half | half | half | half | half | 0 |
| 8.75 | 7 + 0 | A | half | half | half | half | half | half | half |
| 10 | 1 + 6 | B | half | half | half | half | half | half | whole |
| 11.25 | 2 + 5 | D | whole | half | half | whole | half | half | half |
| 12.5 | 3 + 4 | C | whole | half | whole | half | whole | half | half |
| 13.75 | 4 + 3 | C | half | whole | half | whole | half | whole | half |
| 15 | 5 + 2 | D | half | whole | whole | half | whole | whole | whole |
| 16.52 | 6 + 1 | B | whole | whole | whole | whole | whole | whole | half |
| 17.5 | 7 + 0 | A | whole | whole | whole | whole | whole | whole | whole |
| 18.75 | 1 + 6 | B | whole | whole | whole | whole | whole | whole | one + |
| | | | | | | | | | half |
| 20 | 2 + 5 | D | one + half | whole | whole | one + | whole | whole | 1 |
| | | | | | | half | | | |
| 21.25 | 3 + 4 | C | one + half | whole | one + | whole | one + | whole | whole |
| | | | | | half | | half | | |
| 22.5 | 4 + 3 | C | whole | one + | whole | one + | whole | one + | one + |
| | | | | half | | half | | half | half |
| 23.75 | 5 + 2 | D | whole | one + | one + | whole | one + | one + | one + |
| | | | | half | half | | half | half | half |
| 25 | 6 + 1 | B | one + half | one + | one + | one + | one + | one + | whole |
| | | | | half | half | half | half | half | |
| 26.25 | 7 + 0 | A | one + half | one + | one + | one + | one + | one + | one + |
| | | | | half | half | half | half | half | half |
| 27.5 | 1 + 6 | B | one + half | one + | one + | one + | one + | one + | two |
| | | | | half | half | half | half | half | |
| 28.75 | 2 + 5 | D | two | one + | one + | two | one + | one + | one + |
| | | | | half | half | | half | half | half |
| 30 | 3 + 4 | C | two | one + | two | one + | two | one + | one + |
| | | | | half | | half | | half | half |
| 31.25 | 4 + 3 | C | one + half | two | one + | two | one + | two | two |
| | | | | | half | | half | | |
| 32.5 | 5 + 2 | D | one + half | two | two | one + | two | two | two |
| | | | | | | half | | | |
| 33.75 | 6 + 1 | B | two | two | two | two | two | two | one + |
| | | | | | | | | | half |
| 35 | 7 + 0 | A | two | two | two | two | two | two | two |

0 = no dose
half = 5 mg
whole = 10 mg
one + half = 15 mg
two = 20 mg

TABLE 14a
Dual dose allocation schedule, 1 mg base dose, 1 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 8 | 1 + 6 | B | one | 0 | 0 | 0 | 0 | 0 | 0 |
| 9 | 2 + 5 | D | one | 0 | 0 | one | 0 | 0 | 0 |
| 10 | 3 + 4 | C | one | 0 | one | 0 | one | 0 | 0 |
| 11 | 4 + 3 | C | 0 | one | 0 | one | 0 | one | one |
| 12 | 5 + 2 | D | 0 | one | one | 0 | one | one | one |
| 13 | 6 + 1 | B | one | one | one | one | one | one | 0 |
| 14 | 7 + 0 | A | one | one | one | one | one | one | one |

TABLE 14b
Dual dose allocation schedule, 1 mg base dose, 2 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 9 | 1 + 6 | B | one | 0 | 0 | 0 | 0 | 0 | 0 |
| 11 | 2 + 5 | D | one | 0 | 0 | one | 0 | 0 | 0 |
| 13 | 3 + 4 | C | one | 0 | one | 0 | one | 0 | 0 |
| 15 | 4 + 3 | C | 0 | one | 0 | one | 0 | one | one |
| 17 | 5 + 2 | D | 0 | one | one | 0 | one | one | one |
| 19 | 6 + 1 | B | one | one | one | one | one | one | 0 |
| 21 | 7 + 0 | A | one | one | one | one | one | one | one |

TABLE 14c
Dual dose allocation schedule, 1 mg base dose, 2.5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 9.5 | 1 + 6 | B | one | 0 | 0 | 0 | 0 | 0 | 0 |
| 12 | 2 + 5 | D | one | 0 | 0 | one | 0 | 0 | 0 |
| 14.5 | 3 + 4 | C | one | 0 | one | 0 | one | 0 | 0 |
| 17 | 4 + 3 | C | 0 | one | 0 | one | 0 | one | one |
| 19.5 | 5 + 2 | D | 0 | one | one | 0 | one | one | one |
| 22 | 6 + 1 | B | one | one | one | one | one | one | 0 |
| 24.5 | 7 + 0 | A | one | one | one | one | one | one | one |

TABLE 14d
Dual dose allocation schedule, 1 mg base dose, 3 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 10 | 1 + 6 | B | one | 0 | 0 | 0 | 0 | 0 | 0 |
| 13 | 2 + 5 | D | one | 0 | 0 | one | 0 | 0 | 0 |
| 16 | 3 + 4 | C | one | 0 | one | 0 | one | 0 | 0 |
| 19 | 4 + 3 | C | 0 | one | 0 | one | 0 | one | one |
| 22 | 5 + 2 | D | 0 | one | one | 0 | one | one | one |
| 25 | 6 + 1 | B | one | one | one | one | one | one | 0 |
| 28 | 7 + 0 | A | one | one | one | one | one | one | one |

TABLE 14e
Dual dose allocation schedule, 1 mg base dose, 4 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 11 | 1 + 6 | B | one | 0 | 0 | 0 | 0 | 0 | 0 |
| 15 | 2 + 5 | D | one | 0 | 0 | one | 0 | 0 | 0 |
| 19 | 3 + 4 | C | one | 0 | one | 0 | one | 0 | 0 |
| 23 | 4 + 3 | C | 0 | one | 0 | one | 0 | one | one |
| 27 | 5 + 2 | D | 0 | one | one | 0 | one | one | one |
| 31 | 6 + 1 | B | one | one | one | one | one | one | 0 |
| 35 | 7 + 0 | A | one | one | one | one | one | one | one |

TABLE 14f
Dual dose allocation schedule, 1 mg base dose, 5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 12 | 1 + 6 | B | one | 0 | 0 | 0 | 0 | 0 | 0 |
| 17 | 2 + 5 | D | one | 0 | 0 | one | 0 | 0 | 0 |
| 22 | 3 + 4 | C | one | 0 | one | 0 | one | 0 | 0 |
| 27 | 4 + 3 | C | 0 | one | 0 | one | 0 | one | one |
| 32 | 5 + 2 | D | 0 | one | one | 0 | one | one | one |
| 37 | 6 + 1 | B | one | one | one | one | one | one | 0 |
| 42 | 7 + 0 | A | one | one | one | one | one | one | one |

TABLE 14g
Dual dose allocation schedule, 1 mg base dose, 6 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 13 | 1 + 6 | B | one | 0 | 0 | 0 | 0 | 0 | 0 |
| 19 | 2 + 5 | D | one | 0 | 0 | one | 0 | 0 | 0 |
| 25 | 3 + 4 | C | one | 0 | one | 0 | one | 0 | 0 |
| 31 | 4 + 3 | C | 0 | one | 0 | one | 0 | one | one |
| 37 | 5 + 2 | D | 0 | one | one | 0 | one | one | one |
| 43 | 6 + 1 | B | one | one | one | one | one | one | 0 |
| 49 | 7 + 0 | A | one | one | one | one | one | one | one |

TABLE 14h
Dual dose allocation schedule, 1 mg base dose, 7.5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 14.5 | 1 + 6 | B | one | 0 | 0 | 0 | 0 | 0 | 0 |
| 22 | 2 + 5 | D | one | 0 | 0 | one | 0 | 0 | 0 |
| 29.5 | 3 + 4 | C | one | 0 | one | 0 | one | 0 | 0 |
| 37 | 4 + 3 | C | 0 | one | 0 | one | 0 | one | one |
| 44.5 | 5 + 2 | D | 0 | one | one | 0 | one | one | one |
| 52 | 6 + 1 | B | one | one | one | one | one | one | 0 |
| 59.5 | 7 + 0 | A | one | one | one | one | one | one | one |

TABLE 14i
Dual dose allocation schedule, 1 mg base dose, 10 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 7 | 0 + 7 | A | 0 | 0 | 0 | 0 | 0 | 0 | 0 |
| 17 | 1 + 6 | B | one | 0 | 0 | 0 | 0 | 0 | 0 |
| 27 | 2 + 5 | D | one | 0 | 0 | one | 0 | 0 | 0 |
| 37 | 3 + 4 | C | one | 0 | one | 0 | one | 0 | 0 |
| 47 | 4 + 3 | C | 0 | one | 0 | one | 0 | one | one |
| 57 | 5 + 2 | D | 0 | one | one | 0 | one | one | one |
| 67 | 6 + 1 | B | one | one | one | one | one | one | 0 |
| 77 | 7 + 0 | A | one | one | one | one | one | one | one |

TABLE 15a
Dual dose allocation schedule, 2 mg base dose, 1 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 15 | 1 + 6 | B | one | 0 | 0 | 0 | 0 | 0 | 0 |
| 16 | 2 + 5 | D | one | 0 | 0 | one | 0 | 0 | 0 |
| 17 | 3 + 4 | C | one | 0 | one | 0 | one | 0 | 0 |
| 18 | 4 + 3 | C | 0 | one | 0 | one | 0 | one | one |
| 19 | 5 + 2 | D | 0 | one | one | 0 | one | one | one |
| 20 | 6 + 1 | B | one | one | one | one | one | one | 0 |
| 21 | 7 + 0 | A | one | one | one | one | one | one | one |

TABLE 15b
Dual dose allocation schedule, 2 mg base dose, 2 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 16 | 1 + 6 | B | one | 0 | 0 | 0 | 0 | 0 | 0 |
| 18 | 2 + 5 | D | one | 0 | 0 | one | 0 | 0 | 0 |
| 20 | 3 + 4 | C | one | 0 | one | 0 | one | 0 | 0 |
| 22 | 4 + 3 | C | 0 | one | 0 | one | 0 | one | one |
| 24 | 5 + 2 | D | 0 | one | one | 0 | one | one | one |
| 26 | 6 + 1 | B | one | one | one | one | one | one | 0 |
| 28 | 7 + 0 | A | one | one | one | one | one | one | one |

TABLE 15c
Dual dose allocation schedule, 2 mg base dose, 2.5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 16.5 | 1 + 6 | B | one | 0 | 0 | 0 | 0 | 0 | 0 |
| 19 | 2 + 5 | D | one | 0 | 0 | one | 0 | 0 | 0 |
| 21.5 | 3 + 4 | C | one | 0 | one | 0 | one | 0 | 0 |
| 24 | 4 + 3 | C | 0 | one | 0 | one | 0 | one | one |
| 26.5 | 5 + 2 | D | 0 | one | one | 0 | one | one | one |
| 29 | 6 + 1 | B | one | one | one | one | one | one | 0 |
| 31.5 | 7 + 0 | A | one | one | one | one | one | one | one |

TABLE 15d
Dual dose allocation schedule, 2 mg base dose, 3 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 17 | 1 + 6 | B | one | 0 | 0 | 0 | 0 | 0 | 0 |
| 20 | 2 + 5 | D | one | 0 | 0 | one | 0 | 0 | 0 |
| 23 | 3 + 4 | C | one | 0 | one | 0 | one | 0 | 0 |
| 26 | 4 + 3 | C | 0 | one | 0 | one | 0 | one | one |
| 29 | 5 + 2 | D | 0 | one | one | 0 | one | one | one |
| 32 | 6 + 1 | B | one | one | one | one | one | one | 0 |
| 35 | 7 + 0 | A | one | one | one | one | one | one | one |

TABLE 15e
Dual dose allocation schedule, 2 mg base dose, 4 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 18 | 1 + 6 | B | one | 0 | 0 | 0 | 0 | 0 | 0 |
| 22 | 2 + 5 | D | one | 0 | 0 | one | 0 | 0 | 0 |
| 26 | 3 + 4 | C | one | 0 | one | 0 | one | 0 | 0 |
| 30 | 4 + 3 | C | 0 | one | 0 | one | 0 | one | one |
| 34 | 5 + 2 | D | 0 | one | one | 0 | one | one | one |
| 38 | 6 + 1 | B | one | one | one | one | one | one | 0 |
| 42 | 7 + 0 | A | one | one | one | one | one | one | one |

TABLE 15f
Dual dose allocation schedule, 2 mg base dose, 5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 19 | 1 + 6 | B | one | 0 | 0 | 0 | 0 | 0 | 0 |
| 24 | 2 + 5 | D | one | 0 | 0 | one | 0 | 0 | 0 |
| 29 | 3 + 4 | C | one | 0 | one | 0 | one | 0 | 0 |
| 34 | 4 + 3 | C | 0 | one | 0 | one | 0 | one | one |
| 39 | 5 + 2 | D | 0 | one | one | 0 | one | one | one |
| 44 | 6 + 1 | B | one | one | one | one | one | one | 0 |
| 49 | 7 + 0 | A | one | one | one | one | one | one | one |

TABLE 15g
Dual dose allocation schedule, 2 mg base dose, 6 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 20 | 1 + 6 | B | one | 0 | 0 | 0 | 0 | 0 | 0 |
| 26 | 2 + 5 | D | one | 0 | 0 | one | 0 | 0 | 0 |
| 32 | 3 + 4 | C | one | 0 | one | 0 | one | 0 | 0 |
| 38 | 4 + 3 | C | 0 | one | 0 | one | 0 | one | one |
| 44 | 5 + 2 | D | 0 | one | one | 0 | one | one | one |
| 50 | 6 + 1 | B | one | one | one | one | one | one | 0 |
| 56 | 7 + 0 | A | one | one | one | one | one | one | one |

TABLE 15h
Dual dose allocation schedule, 2 mg base dose, 7.5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 21.5 | 1 + 6 | B | one | 0 | 0 | 0 | 0 | 0 | 0 |
| 29 | 2 + 5 | D | one | 0 | 0 | one | 0 | 0 | 0 |
| 36.5 | 3 + 4 | C | one | 0 | one | 0 | one | 0 | 0 |
| 44 | 4 + 3 | C | 0 | one | 0 | one | 0 | one | one |
| 51.5 | 5 + 2 | D | 0 | one | one | 0 | one | one | one |
| 59 | 6 + 1 | B | one | one | one | one | one | one | 0 |
| 66.5 | 7 + 0 | A | one | one | one | one | one | one | one |

TABLE 15i
Dual dose allocation schedule, 2 mg base dose, 10 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 14 | 0 + 7 | A | 0 | 0 | 0 | 0 | 0 | 0 | 0 |
| 24 | 1 + 6 | B | one | 0 | 0 | 0 | 0 | 0 | 0 |
| 34 | 2 + 5 | D | one | 0 | 0 | one | 0 | 0 | 0 |
| 44 | 3 + 4 | C | one | 0 | one | 0 | one | 0 | 0 |
| 54 | 4 + 3 | C | 0 | one | 0 | one | 0 | one | one |
| 64 | 5 + 2 | D | 0 | one | one | 0 | one | one | one |
| 74 | 6 + 1 | B | one | one | one | one | one | one | 0 |
| 84 | 7 + 0 | A | one | one | one | one | one | one | one |

TABLE 16a
Dual dose allocation schedule, 2.5 mg base dose, 1 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 18.5 | 1 + 6 | B | one | 0 | 0 | 0 | 0 | 0 | 0 |
| 19.5 | 2 + 5 | D | one | 0 | 0 | one | 0 | 0 | 0 |
| 20.5 | 3 + 4 | C | one | 0 | one | 0 | one | 0 | 0 |
| 21.5 | 4 + 3 | C | 0 | one | 0 | one | 0 | one | one |
| 22.5 | 5 + 2 | D | 0 | one | one | 0 | one | one | one |
| 23.5 | 6 + 1 | B | one | one | one | one | one | one | 0 |
| 24.5 | 7 + 0 | A | one | one | one | one | one | one | one |

TABLE 16b
Dual dose allocation schedule, 2.5 mg base dose, 2 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 19.5 | 1 + 6 | B | one | 0 | 0 | 0 | 0 | 0 | 0 |
| 21.5 | 2 + 5 | D | one | 0 | 0 | one | 0 | 0 | 0 |
| 23.5 | 3 + 4 | C | one | 0 | one | 0 | one | 0 | 0 |
| 25.5 | 4 + 3 | C | 0 | one | 0 | one | 0 | one | one |
| 27.5 | 5 + 2 | D | 0 | one | one | 0 | one | one | one |
| 29.5 | 6 + 1 | B | one | one | one | one | one | one | 0 |
| 31.5 | 7 + 0 | A | one | one | one | one | one | one | one |

TABLE 16c
Dual dose allocation schedule, 2.5 mg base dose, 2.5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 20 | 1 + 6 | B | one | 0 | 0 | 0 | 0 | 0 | 0 |
| 22.5 | 2 + 5 | D | one | 0 | 0 | one | 0 | 0 | 0 |
| 25 | 3 + 4 | C | one | 0 | one | 0 | one | 0 | 0 |
| 27.5 | 4 + 3 | C | 0 | one | 0 | one | 0 | one | one |
| 30 | 5 + 2 | D | 0 | one | one | 0 | one | one | one |
| 32.5 | 6 + 1 | B | one | one | one | one | one | one | 0 |
| 35 | 7 + 0 | A | one | one | one | one | one | one | one |

TABLE 16d
Dual dose allocation schedule, 2.5 mg base dose, 3 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 20.5 | 1 + 6 | B | one | 0 | 0 | 0 | 0 | 0 | 0 |
| 23.5 | 2 + 5 | D | one | 0 | 0 | one | 0 | 0 | 0 |
| 26.5 | 3 + 4 | C | one | 0 | one | 0 | one | 0 | 0 |
| 29.5 | 4 + 3 | C | 0 | one | 0 | one | 0 | one | one |
| 32.5 | 5 + 2 | D | 0 | one | one | 0 | one | one | one |
| 35.5 | 6 + 1 | B | one | one | one | one | one | one | 0 |
| 38.5 | 7 + 0 | A | one | one | one | one | one | one | one |

TABLE 16e
Dual dose allocation schedule, 2.5 mg base dose, 4 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 21.5 | 1 + 6 | B | one | 0 | 0 | 0 | 0 | 0 | 0 |
| 25.5 | 2 + 5 | D | one | 0 | 0 | one | 0 | 0 | 0 |
| 29.5 | 3 + 4 | C | one | 0 | one | 0 | one | 0 | 0 |
| 33.5 | 4 + 3 | C | 0 | one | 0 | one | 0 | one | one |
| 37.5 | 5 + 2 | D | 0 | one | one | 0 | one | one | one |
| 41.5 | 6 + 1 | B | one | one | one | one | one | one | 0 |
| 45.5 | 7 + 0 | A | one | one | one | one | one | one | one |

TABLE 16f
Dual dose allocation schedule, 2.5 mg base dose, 5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 22.5 | 1 + 6 | B | one | 0 | 0 | 0 | 0 | 0 | 0 |
| 27.5 | 2 + 5 | D | one | 0 | 0 | one | 0 | 0 | 0 |
| 32.5 | 3 + 4 | C | one | 0 | one | 0 | one | 0 | 0 |
| 37.5 | 4 + 3 | C | 0 | one | 0 | one | 0 | one | one |
| 42.5 | 5 + 2 | D | 0 | one | one | 0 | one | one | one |
| 47.5 | 6 + 1 | B | one | one | one | one | one | one | 0 |
| 52.5 | 7 + 0 | A | one | one | one | one | one | one | one |

TABLE 16g
Dual dose allocation schedule, 2.5 mg base dose, 6 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 23.5 | 1 + 6 | B | one | 0 | 0 | 0 | 0 | 0 | 0 |
| 29.5 | 2 + 5 | D | one | 0 | 0 | one | 0 | 0 | 0 |
| 35.5 | 3 + 4 | C | one | 0 | one | 0 | one | 0 | 0 |
| 41.5 | 4 + 3 | C | 0 | one | 0 | one | 0 | one | one |
| 47.5 | 5 + 2 | D | 0 | one | one | 0 | one | one | one |
| 53.5 | 6 + 1 | B | one | one | one | one | one | one | 0 |
| 59.5 | 7 + 0 | A | one | one | one | one | one | one | one |

TABLE 16h
Dual dose allocation schedule, 2.5 mg base dose, 7.5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 25 | 1 + 6 | B | one | 0 | 0 | 0 | 0 | 0 | 0 |
| 32.5 | 2 + 5 | D | one | 0 | 0 | one | 0 | 0 | 0 |
| 40 | 3 + 4 | C | one | 0 | one | 0 | one | 0 | 0 |
| 47.5 | 4 + 3 | C | 0 | one | 0 | one | 0 | one | one |
| 55 | 5 + 2 | D | 0 | one | one | 0 | one | one | one |
| 62.5 | 6 + 1 | B | one | one | one | one | one | one | 0 |
| 70 | 7 + 0 | A | one | one | one | one | one | one | one |

TABLE 16i
Dual dose allocation schedule, 2.5 mg base dose, 10 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 17.5 | 0 + 7 | A | 0 | 0 | 0 | 0 | 0 | 0 | 0 |
| 27.5 | 1 + 6 | B | one | 0 | 0 | 0 | 0 | 0 | 0 |
| 37.5 | 2 + 5 | D | one | 0 | 0 | one | 0 | 0 | 0 |
| 47.5 | 3 + 4 | C | one | 0 | one | 0 | one | 0 | 0 |
| 57.5 | 4 + 3 | C | 0 | one | 0 | one | 0 | one | one |
| 67.5 | 5 + 2 | D | 0 | one | one | 0 | one | one | one |
| 77.5 | 6 + 1 | B | one | one | one | one | one | one | 0 |
| 87.5 | 7 + 0 | A | one | one | one | one | one | one | one |

TABLE 17a
Dual dose allocation schedule, 3 mg base dose, 1 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 22 | 1 + 6 | B | one | 0 | 0 | 0 | 0 | 0 | 0 |
| 23 | 2 + 5 | D | one | 0 | 0 | one | 0 | 0 | 0 |
| 24 | 3 + 4 | C | one | 0 | one | 0 | one | 0 | 0 |
| 25 | 4 + 3 | C | 0 | one | 0 | one | 0 | one | one |
| 26 | 5 + 2 | D | 0 | one | one | 0 | one | one | one |
| 27 | 6 + 1 | B | one | one | one | one | one | one | 0 |
| 28 | 7 + 0 | A | one | one | one | one | one | one | one |

TABLE 17b
Dual dose allocation schedule, 3 mg base dose, 2 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 23 | 1 + 6 | B | one | 0 | 0 | 0 | 0 | 0 | 0 |
| 25 | 2 + 5 | D | one | 0 | 0 | one | 0 | 0 | 0 |
| 27 | 3 + 4 | C | one | 0 | one | 0 | one | 0 | 0 |
| 29 | 4 + 3 | C | 0 | one | 0 | one | 0 | one | one |
| 31 | 5 + 2 | D | 0 | one | one | 0 | one | one | one |
| 33 | 6 + 1 | B | one | one | one | one | one | one | 0 |
| 36 | 7 + 0 | A | one | one | one | one | one | one | one |

TABLE 17c
Dual dose allocation schedule, 3 mg base dose, 2.5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 23.5 | 1 + 6 | B | one | 0 | 0 | 0 | 0 | 0 | 0 |
| 26 | 2 + 5 | D | one | 0 | 0 | one | 0 | 0 | 0 |
| 28.5 | 3 + 4 | C | one | 0 | one | 0 | one | 0 | 0 |
| 31 | 4 + 3 | C | 0 | one | 0 | one | 0 | one | one |
| 33.5 | 5 + 2 | D | 0 | one | one | 0 | one | one | one |
| 36 | 6 + 1 | B | one | one | one | one | one | one | 0 |
| 38.5 | 7 + 0 | A | one | one | one | one | one | one | one |

TABLE 17d
Dual dose allocation schedule, 3 mg base dose, 3 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 24 | 1 + 6 | B | one | 0 | 0 | 0 | 0 | 0 | 0 |
| 27 | 2 + 5 | D | one | 0 | 0 | one | 0 | 0 | 0 |
| 30 | 3 + 4 | C | one | 0 | one | 0 | one | 0 | 0 |
| 33 | 4 + 3 | C | 0 | one | 0 | one | 0 | one | one |
| 33 | 5 + 2 | D | 0 | one | one | 0 | one | one | one |
| 36 | 6 + 1 | B | one | one | one | one | one | one | 0 |
| 39 | 7 + 0 | A | one | one | one | one | one | one | one |

TABLE 17e
Dual dose allocation schedule, 3 mg base dose, 4 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 25 | 1 + 6 | B | one | 0 | 0 | 0 | 0 | 0 | 0 |
| 29 | 2 + 5 | D | one | 0 | 0 | one | 0 | 0 | 0 |
| 33 | 3 + 4 | C | one | 0 | one | 0 | one | 0 | 0 |
| 37 | 4 + 3 | C | 0 | one | 0 | one | 0 | one | one |
| 41 | 5 + 2 | D | 0 | one | one | 0 | one | one | one |
| 45 | 6 + 1 | B | one | one | one | one | one | one | 0 |
| 49 | 7 + 0 | A | one | one | one | one | one | one | one |

TABLE 17f
Dual dose allocation schedule, 3 mg base dose, 5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 26 | 1 + 6 | B | one | 0 | 0 | 0 | 0 | 0 | 0 |
| 31 | 2 + 5 | D | one | 0 | 0 | one | 0 | 0 | 0 |
| 36 | 3 + 4 | C | one | 0 | one | 0 | one | 0 | 0 |
| 41 | 4 + 3 | C | 0 | one | 0 | one | 0 | one | one |
| 46 | 5 + 2 | D | 0 | one | one | 0 | one | one | one |
| 51 | 6 + 1 | B | one | one | one | one | one | one | 0 |
| 56 | 7 + 0 | A | one | one | one | one | one | one | one |

TABLE 17g
Dual dose allocation schedule, 3 mg base dose, 6 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 27 | 1 + 6 | B | one | 0 | 0 | 0 | 0 | 0 | 0 |
| 33 | 2 + 5 | D | one | 0 | 0 | one | 0 | 0 | 0 |
| 39 | 3 + 4 | C | one | 0 | one | 0 | one | 0 | 0 |
| 45 | 4 + 3 | C | 0 | one | 0 | one | 0 | one | one |
| 51 | 5 + 2 | D | 0 | one | one | 0 | one | one | one |
| 57 | 6 + 1 | B | one | one | one | one | one | one | 0 |
| 63 | 7 + 0 | A | one | one | one | one | one | one | one |

TABLE 17h
Dual dose allocation schedule, 3 mg base dose, 7.5 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 28.5 | 1 + 6 | B | one | 0 | 0 | 0 | 0 | 0 | 0 |
| 36 | 2 + 5 | D | one | 0 | 0 | one | 0 | 0 | 0 |
| 43.5 | 3 + 4 | C | one | 0 | one | 0 | one | 0 | 0 |
| 51 | 4 + 3 | C | 0 | one | 0 | one | 0 | one | one |
| 58.5 | 5 + 2 | D | 0 | one | one | 0 | one | one | one |
| 66 | 6 + 1 | B | one | one | one | one | one | one | 0 |
| 73.5 | 7 + 0 | A | one | one | one | one | one | one | one |

TABLE 17i
Dual dose allocation schedule, 3 mg base dose, 10 mg variable dose

| Weekly | Allo- | | | | | | | | |
|---|---|---|---|---|---|---|---|---|---|
| dose | ca- | Pro- | Number of pills | | | | | | |
| (mg) | tion | tocol | M | Tu | We | Th | F | Sa | Su |
| 21 | 0 + 7 | A | 0 | 0 | 0 | 0 | 0 | 0 | 0 |
| 31 | 1 + 6 | B | one | 0 | 0 | 0 | 0 | 0 | 0 |
| 41 | 2 + 5 | D | one | 0 | 0 | one | 0 | 0 | 0 |
| 51 | 3 + 4 | C | one | 0 | one | 0 | one | 0 | 0 |
| 61 | 4 + 3 | C | 0 | one | 0 | one | 0 | one | one |
| 71 | 5 + 2 | D | 0 | one | one | 0 | one | one | one |
| 81 | 6 + 1 | B | one | one | one | one | one | one | 0 |
| 91 | 7 + 0 | A | one | one | one | one | one | one | one |

TABLE 18a
Dual dose allocation schedule, 4 mg base dose, 1 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 29 | 1 + 6 | B | one | 0 | 0 | 0 | 0 | 0 | 0 |
| 30 | 2 + 5 | D | one | 0 | 0 | one | 0 | 0 | 0 |
| 31 | 3 + 4 | C | one | 0 | one | 0 | one | 0 | 0 |
| 32 | 4 + 3 | C | 0 | one | 0 | one | 0 | one | one |
| 33 | 5 + 2 | D | 0 | one | one | 0 | one | one | one |
| 34 | 6 + 1 | B | one | one | one | one | one | one | 0 |
| 35 | 7 + 0 | A | one | one | one | one | one | one | one |

TABLE 18b
Dual dose allocation schedule, 4 mg base dose, 2 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 30 | 1 + 6 | B | one | 0 | 0 | 0 | 0 | 0 | 0 |
| 32 | 2 + 5 | D | one | 0 | 0 | one | 0 | 0 | 0 |
| 34 | 3 + 4 | C | one | 0 | one | 0 | one | 0 | 0 |
| 36 | 4 + 3 | C | 0 | one | 0 | one | 0 | one | one |
| 38 | 5 + 2 | D | 0 | one | one | 0 | one | one | one |
| 40 | 6 + 1 | B | one | one | one | one | one | one | 0 |
| 42 | 7 + 0 | A | one | one | one | one | one | one | one |

TABLE 18c
Dual dose allocation schedule, 4 mg base dose, 2.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 30.5 | 1 + 6 | B | one | 0 | 0 | 0 | 0 | 0 | 0 |
| 33 | 2 + 5 | D | one | 0 | 0 | one | 0 | 0 | 0 |
| 35.5 | 3 + 4 | C | one | 0 | one | 0 | one | 0 | 0 |
| 38 | 4 + 3 | C | 0 | one | 0 | one | 0 | one | one |
| 40.5 | 5 + 2 | D | 0 | one | one | 0 | one | one | one |
| 43 | 6 + 1 | B | one | one | one | one | one | one | 0 |
| 45.5 | 7 + 0 | A | one | one | one | one | one | one | one |

TABLE 18d
Dual dose allocation schedule, 4 mg base dose, 3 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 31 | 1 + 6 | B | one | 0 | 0 | 0 | 0 | 0 | 0 |
| 34 | 2 + 5 | D | one | 0 | 0 | one | 0 | 0 | 0 |
| 37 | 3 + 4 | C | one | 0 | one | 0 | one | 0 | 0 |
| 40 | 4 + 3 | C | 0 | one | 0 | one | 0 | one | one |
| 43 | 5 + 2 | D | 0 | one | one | 0 | one | one | one |
| 46 | 6 + 1 | B | one | one | one | one | one | one | 0 |
| 49 | 7 + 0 | A | one | one | one | one | one | one | one |

TABLE 18e
Dual dose allocation schedule, 4 mg base dose, 4 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 32 | 1 + 6 | B | one | 0 | 0 | 0 | 0 | 0 | 0 |
| 36 | 2 + 5 | D | one | 0 | 0 | one | 0 | 0 | 0 |
| 40 | 3 + 4 | C | one | 0 | one | 0 | one | 0 | 0 |
| 44 | 4 + 3 | C | 0 | one | 0 | one | 0 | one | one |
| 48 | 5 + 2 | D | 0 | one | one | 0 | one | one | one |
| 52 | 6 + 1 | B | one | one | one | one | one | one | 0 |
| 56 | 7 + 0 | A | one | one | one | one | one | one | one |

TABLE 18f
Dual dose allocation schedule, 4 mg base dose, 5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 35.5 | 1 + 6 | B | one | 0 | 0 | 0 | 0 | 0 | 0 |
| 43 | 2 + 5 | D | one | 0 | 0 | one | 0 | 0 | 0 |
| 50.5 | 3 + 4 | C | one | 0 | one | 0 | one | 0 | 0 |
| 58 | 4 + 3 | C | 0 | one | 0 | one | 0 | one | one |
| 65.5 | 5 + 2 | D | 0 | one | one | 0 | one | one | one |
| 73 | 6 + 1 | B | one | one | one | one | one | one | 0 |
| 80.5 | 7 + 0 | A | one | one | one | one | one | one | one |

TABLE 18g
Dual dose allocation schedule, 4 mg base dose, 6 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 34 | 1 + 6 | B | one | 0 | 0 | 0 | 0 | 0 | 0 |
| 40 | 2 + 5 | D | one | 0 | 0 | one | 0 | 0 | 0 |
| 46 | 3 + 4 | C | one | 0 | one | 0 | one | 0 | 0 |
| 52 | 4 + 3 | C | 0 | one | 0 | one | 0 | one | one |
| 58 | 5 + 2 | D | 0 | one | one | 0 | one | one | one |
| 64 | 6 + 1 | B | one | one | one | one | one | one | 0 |
| 70 | 7 + 0 | A | one | one | one | one | one | one | one |

TABLE 18h
Dual dose allocation schedule, 4 mg base dose, 7.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 35.5 | 1 + 6 | B | one | 0 | 0 | 0 | 0 | 0 | 0 |
| 43 | 2 + 5 | D | one | 0 | 0 | one | 0 | 0 | 0 |
| 50.5 | 3 + 4 | C | one | 0 | one | 0 | one | 0 | 0 |
| 58 | 4 + 3 | C | 0 | one | 0 | one | 0 | one | one |
| 65.5 | 5 + 2 | D | 0 | one | one | 0 | one | one | one |
| 73 | 6 + 1 | B | one | one | one | one | one | one | 0 |
| 80.5 | 7 + 0 | A | one | one | one | one | one | one | one |

TABLE 18i
Dual dose allocation schedule, 4 mg base dose, 10 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 28 | 0 + 7 | A | 0 | 0 | 0 | 0 | 0 | 0 | 0 |
| 38 | 1 + 6 | B | one | 0 | 0 | 0 | 0 | 0 | 0 |
| 48 | 2 + 5 | D | one | 0 | 0 | one | 0 | 0 | 0 |
| 58 | 3 + 4 | C | one | 0 | one | 0 | one | 0 | 0 |
| 68 | 4 + 3 | C | 0 | one | 0 | one | 0 | one | one |
| 78 | 5 + 2 | D | 0 | one | one | 0 | one | one | one |
| 88 | 6 + 1 | B | one | one | one | one | one | one | 0 |
| 98 | 7 + 0 | A | one | one | one | one | one | one | one |

TABLE 19a
Dual dose allocation schedule, 5 mg base dose, 1 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 36 | 1 + 6 | B | one | 0 | 0 | 0 | 0 | 0 | 0 |
| 37 | 2 + 5 | D | one | 0 | 0 | one | 0 | 0 | 0 |
| 38 | 3 + 4 | C | one | 0 | one | 0 | one | 0 | 0 |
| 39 | 4 + 3 | C | 0 | one | 0 | one | 0 | one | one |
| 40 | 5 + 2 | D | 0 | one | one | 0 | one | one | one |
| 41 | 6 + 1 | B | one | one | one | one | one | one | 0 |
| 42 | 7 + 0 | A | one | one | one | one | one | one | one |

TABLE 19b
Dual dose allocation schedule, 5 mg base dose, 2 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 37 | 1 + 6 | B | one | 0 | 0 | 0 | 0 | 0 | 0 |
| 39 | 2 + 5 | D | one | 0 | 0 | one | 0 | 0 | 0 |
| 41 | 3 + 4 | C | one | 0 | one | 0 | one | 0 | 0 |
| 43 | 4 + 3 | C | 0 | one | 0 | one | 0 | one | one |
| 45 | 5 + 2 | D | 0 | one | one | 0 | one | one | one |
| 47 | 6 + 1 | B | one | one | one | one | one | one | 0 |
| 49 | 7 + 0 | A | one | one | one | one | one | one | one |

TABLE 19c
Dual dose allocation schedule, 5 mg base dose, 2.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 37.5 | 1 + 6 | B | one | 0 | 0 | 0 | 0 | 0 | 0 |
| 40 | 2 + 5 | D | one | 0 | 0 | one | 0 | 0 | 0 |
| 42.5 | 3 + 4 | C | one | 0 | one | 0 | one | 0 | 0 |
| 45 | 4 + 3 | C | 0 | one | 0 | one | 0 | one | one |
| 47.5 | 5 + 2 | D | 0 | one | one | 0 | one | one | one |
| 50 | 6 + 1 | B | one | one | one | one | one | one | 0 |
| 52.5 | 7 + 0 | A | one | one | one | one | one | one | one |

TABLE 19d
Dual dose allocation schedule, 5 mg base dose, 3 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 38 | 1 + 6 | B | one | 0 | 0 | 0 | 0 | 0 | 0 |
| 41 | 2 + 5 | D | one | 0 | 0 | one | 0 | 0 | 0 |
| 44 | 3 + 4 | C | one | 0 | one | 0 | one | 0 | 0 |
| 47 | 4 + 3 | C | 0 | one | 0 | one | 0 | one | one |
| 50 | 5 + 2 | D | 0 | one | one | 0 | one | one | one |
| 53 | 6 + 1 | B | one | one | one | one | one | one | 0 |
| 56 | 7 + 0 | A | one | one | one | one | one | one | one |

TABLE 19e
Dual dose allocation schedule, 5 mg base dose, 4 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 39 | 1 + 6 | B | one | 0 | 0 | 0 | 0 | 0 | 0 |
| 43 | 2 + 5 | D | one | 0 | 0 | one | 0 | 0 | 0 |
| 47 | 3 + 4 | C | one | 0 | one | 0 | one | 0 | 0 |
| 51 | 4 + 3 | C | 0 | one | 0 | one | 0 | one | one |
| 55 | 5 + 2 | D | 0 | one | one | 0 | one | one | one |
| 59 | 6 + 1 | B | one | one | one | one | one | one | 0 |
| 63 | 7 + 0 | A | one | one | one | one | one | one | one |

TABLE 19f
Dual dose allocation schedule, 5 mg base dose, 5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 40 | 1 + 6 | B | one | 0 | 0 | 0 | 0 | 0 | 0 |
| 45 | 2 + 5 | D | one | 0 | 0 | one | 0 | 0 | 0 |
| 50 | 3 + 4 | C | one | 0 | one | 0 | one | 0 | 0 |
| 55 | 4 + 3 | C | 0 | one | 0 | one | 0 | one | one |
| 60 | 5 + 2 | D | 0 | one | one | 0 | one | one | one |
| 65 | 6 + 1 | B | one | one | one | one | one | one | 0 |
| 70 | 7 + 0 | A | one | one | one | one | one | one | one |

TABLE 19g
Dual dose allocation schedule, 5 mg base dose, 6 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 41 | 1 + 6 | B | one | 0 | 0 | 0 | 0 | 0 | 0 |
| 47 | 2 + 5 | D | one | 0 | 0 | one | 0 | 0 | 0 |
| 53 | 3 + 4 | C | one | 0 | one | 0 | one | 0 | 0 |
| 59 | 4 + 3 | C | 0 | one | 0 | one | 0 | one | one |
| 65 | 5 + 2 | D | 0 | one | one | 0 | one | one | one |
| 71 | 6 + 1 | B | one | one | one | one | one | one | 0 |
| 77 | 7 + 0 | A | one | one | one | one | one | one | one |

TABLE 19h
Dual dose allocation schedule, 5 mg base dose, 7.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 42.5 | 1 + 6 | B | one | 0 | 0 | 0 | 0 | 0 | 0 |
| 50 | 2 + 5 | D | one | 0 | 0 | one | 0 | 0 | 0 |
| 57.5 | 3 + 4 | C | one | 0 | one | 0 | one | 0 | 0 |
| 65 | 4 + 3 | C | 0 | one | 0 | one | 0 | one | one |
| 72.5 | 5 + 2 | D | 0 | one | one | 0 | one | one | one |
| 80 | 6 + 1 | B | one | one | one | one | one | one | 0 |
| 87.5 | 7 + 0 | A | one | one | one | one | one | one | one |

TABLE 19i
Dual dose allocation schedule, 5 mg base dose, 10 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 35 | 0 + 7 | A | 0 | 0 | 0 | 0 | 0 | 0 | 0 |
| 45 | 1 + 6 | B | one | 0 | 0 | 0 | 0 | 0 | 0 |
| 55 | 2 + 5 | D | one | 0 | 0 | one | 0 | 0 | 0 |
| 65 | 3 + 4 | C | one | 0 | one | 0 | one | 0 | 0 |
| 75 | 4 + 3 | C | 0 | one | 0 | one | 0 | one | one |
| 85 | 5 + 2 | D | 0 | one | one | 0 | one | one | one |
| 95 | 6 + 1 | B | one | one | one | one | one | one | 0 |
| 105 | 7 + 0 | A | one | one | one | one | one | one | one |

TABLE 20a
Dual dose allocation schedule, 6 mg base dose, 1 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 43 | 1 + 6 | B | one | 0 | 0 | 0 | 0 | 0 | 0 |
| 44 | 2 + 5 | D | one | 0 | 0 | one | 0 | 0 | 0 |
| 45 | 3 + 4 | C | one | 0 | one | 0 | one | 0 | 0 |
| 46 | 4 + 3 | C | 0 | one | 0 | one | 0 | one | one |
| 47 | 5 + 2 | D | 0 | one | one | 0 | one | one | one |
| 48 | 6 + 1 | B | one | one | one | one | one | one | 0 |
| 49 | 7 + 0 | A | one | one | one | one | one | one | one |

TABLE 20b
Dual dose allocation schedule, 6 mg base dose, 2 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 44 | 1 + 6 | B | one | 0 | 0 | 0 | 0 | 0 | 0 |
| 46 | 2 + 5 | D | one | 0 | 0 | one | 0 | 0 | 0 |
| 48 | 3 + 4 | C | one | 0 | one | 0 | one | 0 | 0 |
| 50 | 4 + 3 | C | 0 | one | 0 | one | 0 | one | one |
| 52 | 5 + 2 | D | 0 | one | one | 0 | one | one | one |
| 54 | 6 + 1 | B | one | one | one | one | one | one | 0 |
| 56 | 7 + 0 | A | one | one | one | one | one | one | one |

TABLE 20c
Dual dose allocation schedule, 6 mg base dose, 2.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 44.5 | 1 + 6 | B | one | 0 | 0 | 0 | 0 | 0 | 0 |
| 47 | 2 + 5 | D | one | 0 | 0 | one | 0 | 0 | 0 |
| 49.5 | 3 + 4 | C | one | 0 | one | 0 | one | 0 | 0 |
| 52 | 4 + 3 | C | 0 | one | 0 | one | 0 | one | one |
| 54.5 | 5 + 2 | D | 0 | one | one | 0 | one | one | one |
| 57 | 6 + 1 | B | one | one | one | one | one | one | 0 |
| 59.5 | 7 + 0 | A | one | one | one | one | one | one | one |

TABLE 20d
Dual dose allocation schedule, 6 mg base dose, 3 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 45 | 1 + 6 | B | one | 0 | 0 | 0 | 0 | 0 | 0 |
| 48 | 2 + 5 | D | one | 0 | 0 | one | 0 | 0 | 0 |
| 51 | 3 + 4 | C | one | 0 | one | 0 | one | 0 | 0 |
| 54 | 4 + 3 | C | 0 | one | 0 | one | 0 | one | one |
| 57 | 5 + 2 | D | 0 | one | one | 0 | one | one | one |
| 60 | 6 + 1 | B | one | one | one | one | one | one | 0 |
| 63 | 7 + 0 | A | one | one | one | one | one | one | one |

TABLE 20e
Dual dose allocation schedule, 6 mg base dose, 4 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 46 | 1 + 6 | B | one | 0 | 0 | 0 | 0 | 0 | 0 |
| 50 | 2 + 5 | D | one | 0 | 0 | one | 0 | 0 | 0 |
| 54 | 3 + 4 | C | one | 0 | one | 0 | one | 0 | 0 |
| 58 | 4 + 3 | C | 0 | one | 0 | one | 0 | one | one |
| 62 | 5 + 2 | D | 0 | one | one | 0 | one | one | one |
| 66 | 6 + 1 | B | one | one | one | one | one | one | 0 |
| 70 | 7 + 0 | A | one | one | one | one | one | one | one |

TABLE 20f
Dual dose allocation schedule, 6 mg base dose, 5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 47 | 1 + 6 | B | one | 0 | 0 | 0 | 0 | 0 | 0 |
| 52 | 2 + 5 | D | one | 0 | 0 | one | 0 | 0 | 0 |
| 57 | 3 + 4 | C | one | 0 | one | 0 | one | 0 | 0 |
| 62 | 4 + 3 | C | 0 | one | 0 | one | 0 | one | one |
| 67 | 5 + 2 | D | 0 | one | one | 0 | one | one | one |
| 72 | 6 + 1 | B | one | one | one | one | one | one | 0 |
| 77 | 7 + 0 | A | one | one | one | one | one | one | one |

TABLE 20g
Dual dose allocation schedule, 6 mg base dose, 6 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 48 | 1 + 6 | B | one | 0 | 0 | 0 | 0 | 0 | 0 |
| 54 | 2 + 5 | D | one | 0 | 0 | one | 0 | 0 | 0 |
| 60 | 3 + 4 | C | one | 0 | one | 0 | one | 0 | 0 |
| 66 | 4 + 3 | C | 0 | one | 0 | one | 0 | one | one |
| 72 | 5 + 2 | D | 0 | one | one | 0 | one | one | one |
| 78 | 6 + 1 | B | one | one | one | one | one | one | 0 |
| 84 | 7 + 0 | A | one | one | one | one | one | one | one |

TABLE 20h
Dual dose allocation schedule, 6 mg base dose, 7.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 49.5 | 1 + 6 | B | one | 0 | 0 | 0 | 0 | 0 | 0 |
| 57 | 2 + 5 | D | one | 0 | 0 | one | 0 | 0 | 0 |
| 64.5 | 3 + 4 | C | one | 0 | one | 0 | one | 0 | 0 |
| 72 | 4 + 3 | C | 0 | one | 0 | one | 0 | one | one |
| 79.5 | 5 + 2 | D | 0 | one | one | 0 | one | one | one |
| 87 | 6 + 1 | B | one | one | one | one | one | one | 0 |
| 94.5 | 7 + 0 | A | one | one | one | one | one | one | one |

TABLE 20i
Dual dose allocation schedule, 6 mg base dose, 10 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 42 | 0 + 7 | A | 0 | 0 | 0 | 0 | 0 | 0 | 0 |
| 52 | 1 + 6 | B | one | 0 | 0 | 0 | 0 | 0 | 0 |
| 62 | 2 + 5 | D | one | 0 | 0 | one | 0 | 0 | 0 |
| 72 | 3 + 4 | C | one | 0 | one | 0 | one | 0 | 0 |
| 82 | 4 + 3 | C | 0 | one | 0 | one | 0 | one | one |
| 92 | 5 + 2 | D | 0 | one | one | 0 | one | one | one |
| 102 | 6 + 1 | B | one | one | one | one | one | one | 0 |
| 112 | 7 + 0 | A | one | one | one | one | one | one | one |

TABLE 21a
Dual dose allocation schedule, 7.5 mg base dose, 1 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 53.5 | 1 + 6 | B | one | 0 | 0 | 0 | 0 | 0 | 0 |
| 54.5 | 2 + 5 | D | one | 0 | 0 | one | 0 | 0 | 0 |
| 55.5 | 3 + 4 | C | one | 0 | one | 0 | one | 0 | 0 |
| 56.5 | 4 + 3 | C | 0 | one | 0 | one | 0 | one | one |
| 57.5 | 5 + 2 | D | 0 | one | one | 0 | one | one | one |
| 58.5 | 6 + 1 | B | one | one | one | one | one | one | 0 |
| 59.5 | 7 + 0 | A | one | one | one | one | one | one | one |

TABLE 21b
Dual dose allocation schedule, 7.5 mg base dose, 2 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 54.5 | 1 + 6 | B | one | 0 | 0 | 0 | 0 | 0 | 0 |
| 56.5 | 2 + 5 | D | one | 0 | 0 | one | 0 | 0 | 0 |
| 58.5 | 3 + 4 | C | one | 0 | one | 0 | one | 0 | 0 |
| 60.5 | 4 + 3 | C | 0 | one | 0 | one | 0 | one | one |
| 62.5 | 5 + 2 | D | 0 | one | one | 0 | one | one | one |
| 64.5 | 6 + 1 | B | one | one | one | one | one | one | 0 |
| 66.5 | 7 + 0 | A | one | one | one | one | one | one | one |

TABLE 21c
Dual dose allocation schedule, 7.5 mg base dose, 2.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 55 | 1 + 6 | B | one | 0 | 0 | 0 | 0 | 0 | 0 |
| 57.5 | 2 + 5 | D | one | 0 | 0 | one | 0 | 0 | 0 |
| 60 | 3 + 4 | C | one | 0 | one | 0 | one | 0 | 0 |
| 62.5 | 4 + 3 | C | 0 | one | 0 | one | 0 | one | one |
| 65 | 5 + 2 | D | 0 | one | one | 0 | one | one | one |
| 67.5 | 6 + 1 | B | one | one | one | one | one | one | 0 |
| 70 | 7 + 0 | A | one | one | one | one | one | one | one |

TABLE 21d
Dual dose allocation schedule, 7.5 mg base dose, 3 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 10 | 1 + 6 | B | one | 0 | 0 | 0 | 0 | 0 | 0 |
| 55.5 | 2 + 5 | D | one | 0 | 0 | one | 0 | 0 | 0 |
| 58.5 | 3 + 4 | C | one | 0 | one | 0 | one | 0 | 0 |
| 61.5 | 4 + 3 | C | 0 | one | 0 | one | 0 | one | one |
| 64.5 | 5 + 2 | D | 0 | one | one | 0 | one | one | one |
| 67.5 | 6 + 1 | B | one | one | one | one | one | one | 0 |
| 70.5 | 7 + 0 | A | one | one | one | one | one | one | one |

TABLE 21e
Dual dose allocation schedule, 7.5 mg base dose, 4 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 56.5 | 1 + 6 | B | one | 0 | 0 | 0 | 0 | 0 | 0 |
| 60.5 | 2 + 5 | D | one | 0 | 0 | one | 0 | 0 | 0 |
| 64.5 | 3 + 4 | C | one | 0 | one | 0 | one | 0 | 0 |
| 68.5 | 4 + 3 | C | 0 | one | 0 | one | 0 | one | one |
| 72.5 | 5 + 2 | D | 0 | one | one | 0 | one | one | one |
| 76.5 | 6 + 1 | B | one | one | one | one | one | one | 0 |
| 80.5 | 7 + 0 | A | one | one | one | one | one | one | one |

TABLE 21f
Dual dose allocation schedule, 7.5 mg base dose, 5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 57.5 | 1 + 6 | B | one | 0 | 0 | 0 | 0 | 0 | 0 |
| 62.5 | 2 + 5 | D | one | 0 | 0 | one | 0 | 0 | 0 |
| 67.5 | 3 + 4 | C | one | 0 | one | 0 | one | 0 | 0 |
| 72.5 | 4 + 3 | C | 0 | one | 0 | one | 0 | one | one |
| 77.5 | 5 + 2 | D | 0 | one | one | 0 | one | one | one |
| 82.5 | 6 + 1 | B | one | one | one | one | one | one | 0 |
| 87.5 | 7 + 0 | A | one | one | one | one | one | one | one |

TABLE 21g
Dual dose allocation schedule, 7.5 mg base dose, 6 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 60 | 1 + 6 | B | one | 0 | 0 | 0 | 0 | 0 | 0 |
| 67.5 | 2 + 5 | D | one | 0 | 0 | one | 0 | 0 | 0 |
| 75 | 3 + 4 | C | one | 0 | one | 0 | one | 0 | 0 |
| 82.5 | 4 + 3 | C | 0 | one | 0 | one | 0 | one | one |
| 90 | 5 + 2 | D | 0 | one | one | 0 | one | one | one |
| 97.5 | 6 + 1 | B | one | one | one | one | one | one | 0 |
| 105 | 7 + 0 | A | one | one | one | one | one | one | one |

TABLE 21h
Dual dose allocation schedule, 7.5 mg base dose, 7.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 60 | 1 + 6 | B | one | 0 | 0 | 0 | 0 | 0 | 0 |
| 67.5 | 2 + 5 | D | one | 0 | 0 | one | 0 | 0 | 0 |
| 75 | 3 + 4 | C | one | 0 | one | 0 | one | 0 | 0 |
| 82.5 | 4 + 3 | C | 0 | one | 0 | one | 0 | one | one |
| 90 | 5 + 2 | D | 0 | one | one | 0 | one | one | one |
| 97.5 | 6 + 1 | B | one | one | one | one | one | one | 0 |
| 105 | 7 + 0 | A | one | one | one | one | one | one | one |

TABLE 21i
Dual dose allocation schedule, 7.5 mg base dose, 10 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 52.5 | 0 + 7 | A | 0 | 0 | 0 | 0 | 0 | 0 | 0 |
| 62.5 | 1 + 6 | B | one | 0 | 0 | 0 | 0 | 0 | 0 |
| 72.5 | 2 + 5 | D | one | 0 | 0 | one | 0 | 0 | 0 |
| 82.5 | 3 + 4 | C | one | 0 | one | 0 | one | 0 | 0 |
| 92.5 | 4 + 3 | C | 0 | one | 0 | one | 0 | one | one |
| 102.5 | 5 + 2 | D | 0 | one | one | 0 | one | one | one |
| 112.5 | 6 + 1 | B | one | one | one | one | one | one | 0 |
| 122.5 | 7 + 0 | A | one | one | one | one | one | one | one |

TABLE 22a
Dual dose allocation schedule, 10 mg base dose, 1 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 71 | 1 + 6 | B | one | 0 | 0 | 0 | 0 | 0 | 0 |
| 72 | 2 + 5 | D | one | 0 | 0 | one | 0 | 0 | 0 |
| 73 | 3 + 4 | C | one | 0 | one | 0 | one | 0 | 0 |
| 74 | 4 + 3 | C | 0 | one | 0 | one | 0 | one | one |
| 75 | 5 + 2 | D | 0 | one | one | 0 | one | one | one |
| 76 | 6 + 1 | B | one | one | one | one | one | one | 0 |
| 77 | 7 + 0 | A | one | one | one | one | one | one | one |

TABLE 22b
Dual dose allocation schedule, 10 mg base dose, 2 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 72 | 1 + 6 | B | one | 0 | 0 | 0 | 0 | 0 | 0 |
| 74 | 2 + 5 | D | one | 0 | 0 | one | 0 | 0 | 0 |
| 76 | 3 + 4 | C | one | 0 | one | 0 | one | 0 | 0 |
| 78 | 4 + 3 | C | 0 | one | 0 | one | 0 | one | one |
| 80 | 5 + 2 | D | 0 | one | one | 0 | one | one | one |
| 82 | 6 + 1 | B | one | one | one | one | one | one | 0 |
| 84 | 7 + 0 | A | one | one | one | one | one | one | one |

TABLE 22c
Dual dose allocation schedule, 10 mg base dose, 2.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 72.5 | 1 + 6 | B | one | 0 | 0 | 0 | 0 | 0 | 0 |
| 75 | 2 + 5 | D | one | 0 | 0 | one | 0 | 0 | 0 |
| 77.5 | 3 + 4 | C | one | 0 | one | 0 | one | 0 | 0 |
| 80 | 4 + 3 | C | 0 | one | 0 | one | 0 | one | one |
| 82.5 | 5 + 2 | D | 0 | one | one | 0 | one | one | one |
| 85 | 6 + 1 | B | one | one | one | one | one | one | 0 |
| 87.5 | 7 + 0 | A | one | one | one | one | one | one | one |

TABLE 22d
Dual dose allocation schedule, 10 mg base dose, 3 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 73 | 1 + 6 | B | one | 0 | 0 | 0 | 0 | 0 | 0 |
| 76 | 2 + 5 | D | one | 0 | 0 | one | 0 | 0 | 0 |
| 79 | 3 + 4 | C | one | 0 | one | 0 | one | 0 | 0 |
| 82 | 4 + 3 | C | 0 | one | 0 | one | 0 | one | one |
| 85 | 5 + 2 | D | 0 | one | one | 0 | one | one | one |
| 88 | 6 + 1 | B | one | one | one | one | one | one | 0 |
| 91 | 7 + 0 | A | one | one | one | one | one | one | one |

TABLE 22e
Dual dose allocation schedule, 10 mg base dose, 4 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 74 | 1 + 6 | B | one | 0 | 0 | 0 | 0 | 0 | 0 |
| 78 | 2 + 5 | D | one | 0 | 0 | one | 0 | 0 | 0 |
| 82 | 3 + 4 | C | one | 0 | one | 0 | one | 0 | 0 |
| 86 | 4 + 3 | C | 0 | one | 0 | one | 0 | one | one |
| 90 | 5 + 2 | D | 0 | one | one | 0 | one | one | one |
| 94 | 6 + 1 | B | one | one | one | one | one | one | 0 |
| 98 | 7 + 0 | A | one | one | one | one | one | one | one |

TABLE 22f
Dual dose allocation schedule, 10 mg base dose, 5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 75 | 1 + 6 | B | one | 0 | 0 | 0 | 0 | 0 | 0 |
| 80 | 2 + 5 | D | one | 0 | 0 | one | 0 | 0 | 0 |
| 85 | 3 + 4 | C | one | 0 | one | 0 | one | 0 | 0 |
| 90 | 4 + 3 | C | 0 | one | 0 | one | 0 | one | one |
| 95 | 5 + 2 | D | 0 | one | one | 0 | one | one | one |
| 100 | 6 + 1 | B | one | one | one | one | one | one | 0 |
| 105 | 7 + 0 | A | one | one | one | one | one | one | one |

TABLE 22g
Dual dose allocation schedule, 10 mg base dose, 6 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 76 | 1 + 6 | B | one | 0 | 0 | 0 | 0 | 0 | 0 |
| 82 | 2 + 5 | D | one | 0 | 0 | one | 0 | 0 | 0 |
| 88 | 3 + 4 | C | one | 0 | one | 0 | one | 0 | 0 |
| 94 | 4 + 3 | C | 0 | one | 0 | one | 0 | one | one |
| 100 | 5 + 2 | D | 0 | one | one | 0 | one | one | one |
| 106 | 6 + 1 | B | one | one | one | one | one | one | 0 |
| 112 | 7 + 0 | A | one | one | one | one | one | one | one |

TABLE 22h
Dual dose allocation schedule, 10 mg base dose, 7.5 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 77.5 | 1 + 6 | B | one | 0 | 0 | 0 | 0 | 0 | 0 |
| 85 | 2 + 5 | D | one | 0 | 0 | one | 0 | 0 | 0 |
| 92.5 | 3 + 4 | C | one | 0 | one | 0 | one | 0 | 0 |
| 100 | 4 + 3 | C | 0 | one | 0 | one | 0 | one | one |
| 107.5 | 5 + 2 | D | 0 | one | one | 0 | one | one | one |
| 115 | 6 + 1 | B | one | one | one | one | one | one | 0 |
| 122.5 | 7 + 0 | A | one | one | one | one | one | one | one |

TABLE 22i
Dual dose allocation schedule, 10 mg base dose, 10 mg variable dose

| Weekly dose | | | Number of pills | | | | | | |
|---|---|---|---|---|---|---|---|---|---|
| (mg) | Allocation | Protocol | M | Tu | We | Th | F | Sa | Su |
| 70 | 0 + 7 | A | 0 | 0 | 0 | 0 | 0 | 0 | 0 |
| 80 | 1 + 6 | B | one | 0 | 0 | 0 | 0 | 0 | 0 |
| 90 | 2 + 5 | D | one | 0 | 0 | one | 0 | 0 | 0 |
| 100 | 3 + 4 | C | one | 0 | one | 0 | one | 0 | 0 |
| 110 | 4 + 3 | C | 0 | one | 0 | one | 0 | one | one |
| 120 | 5 + 2 | D | 0 | one | one | 0 | one | one | one |
| 130 | 6 + 1 | B | one | one | one | one | one | one | 0 |
| 140 | 7 + 0 | A | one | one | one | one | one | one | one |

The methods described herein may further comprise inputting another pill size other than the current anticoagulant pill size, e.g, if the determined new dose allocated for the next time period does not fall within the preselected list of doses ranging from a minimum dose to a maximum dose for the anticoagulant pill size, or if for any other reason another anticoagulant pill size is desired.

The methods described herein also provide a new dose of an anticoagulant allocated over a time period. The new allocated dose can be provided to, for example, a physician, another healthcare provider, patient, parent or caregiver of patient, etc. The new allocated dose can also be provided on a printout, by audible means, by electronic means, any other means for conveying dose information, or any combination of means thereof. For instance, the new allocated dose can be provided on a printout, e.g., intended for the patient, with pill size information, daily dosage for the next time period, and information as to how many pills to take daily (e.g., whether to take ½ a pill, 1 pill, 1½ pills, or 2 pills, or other specific dose). A printout can also have other types of information on it, for example, the patient's name, medical history, physician information, date, clinic information, indications, instructions for taking the anticoagulant, side effects, contact information, warnings, cautions, or any other custom message.

The new allocated dose can also be provided by audible means. For example, a device may be attached to the patient that gives an audible signal daily at the time the anticoagulant should be taken. The audible signal may be, for example, a bell, a buzz, a ring, a ring tone, or a voice disclosing the name and amount of anticoagulant to take, or any other pertinent information. The new allocated dose can alternatively be provided electronically. For example, the new allocated dose can be provided via email, website, computer, telephone, cell phone, text message, BlackBerry, Bluetooth, PDA, wireless device, or any other device that allows for electronic transmission.

Once a patient has taken the new allocated dose for the next time period and the next time period (or a multiple thereof) has expired, the patient may return to his or her physician or other healthcare provider to obtain a new allocated dose for a next time period, using the methods for determining anticoagulant dosing described herein or any other methods. The methods can be repeated after consecutive time periods as desired.

### Apparatus for Management of Anticoagulation Therapy

Disclosed herein are apparatuses for management of a patient's anticoagulation therapy. The apparatus described herein include, for example, means for accepting (a) the patient's cumulative dose of anticoagulant from a previous time period, (b) the patient's current INR, (c) an INR target, and (d) current anticoagulant pill size, into a series of equations; means for determining a new dose allocated for a next time period, chosen from a preselected list of doses ranging from a minimum dose to a maximum dose for the anticoagulant pill size; and means for providing the new allocated dose.

Means for accepting (a) the patient's cumulative dose of anticoagulant from a previous time period, (b) the patient's current INR, (c) an INR target, and (d) current anticoagulant pill size, into a series of equations include, for example, a computer program that provides a user interface, a downloaded software program, an email program, an interactive web-based program, an internet program, or any other type of computer or electronic program. Other means for accepting include, for example, manual device, a calculator, other electronic means, audible means, or any other means of accepting information into a series of equations and calculating an output. The means for accepting may be a stand alone means or may be means integrated into a system, for example, an electronic medical records system, or may feed into a central database, for example, to link separate clinics and create a virtual anticoagulation clinic.

The anticoagulant may be any of the anticoagulants listed herein, or a combination of more than one anticoagulant. Preferably, the anticoagulant is warfarin or a warfarin derivative. The cumulative dose of anticoagulant may be calculated by, e.g., the total amount of anticoagulant taken over the previous time period, the sum of the amount of anticoagulant taken daily over the previous time period, or any other calculation that can be used to determine the patient's total anticoagulant intake over the previous time period. The previous time period from which a patient's cumulative dose is determined may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. Preferably, the time period is 1 week. The patient's current INR is, for example, the INR of the patient taken within approximately a 24 hour time period. An INR target may be from about 2.0 and about 3.0, about 2.1 and about 3.1, about 2.2 and about 3.2, about 2.3 and about 3.3, about 2.4 and about 3.4, between about 2.5 and about 3.5, between about 2.0 and about 4.0, or any other INR target between about 2.0 and about 4.0. The patient's current anticoagulant pill size is the pill size of anticoagulant that the patient is currently taking, or, alternatively, it may be any other pill size of anticoagulant. Other data points may be inputted into the series of equations, such as a patient's genetic factors, age, sex, diet, drug interactions, illness, and/or compliance with recommended dosing schedules, or any other information that may affect a patient's response to anticoagulant therapy.

The series of equations into which the above data is entered may be any set of mathematical calculations designed to calculate a new dose of anticoagulant allocated for a next time period based on the patient's cumulative dose of anticoagulant from a previous time period. For example, for an INR target of 2.0 to 3.0, the series of equations may take the form of equations as illustrated in Table 1. For an INR target of 2.5 to 3.5, the series of equations may take the form of equations as illustrated in Table 2.

The apparatuses as described herein further comprise means for determining a new dose allocated for a next time period chosen from a preselected list of doses ranging from a minimum dose to a maximum dose for the anticoagulant pill size, based on the output calculated from the series of equations. The means for determining a new dose may include, for example, a computer program that can perform mathematical calculations and provide an output. Such a computer program can be written in any type of programming language, for example, Java, JavaScript, C++, Matlab, or any other programming language or code. Other means for allocating a new dose include, for example, manual, a calculator, other electronic means, or any other means for performing mathematical calculations and providing an output.

The allocated dose is expressed as a dose spread out over a time period. As a non limiting example, an allocated dose may be a daily dose given over a time period greater than one day. The next time period for which a new dose is allocated may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. The time period may be the same or different from the previous time period. Preferably, the time period is 1 week. The new dose may be allocated for the next time period chosen from a preselected list of doses ranging from a minimum dose to a maximum dose for the anticoagulant pill size. The anticoagulant pill size can be any commercially available pill size of anticoagulant or any other size of pill, e.g., 1 mg, 2 mg, 5 mg, or 7.5 mg. Preferably, when warfarin is the anticoagulant, the pill sizes used are 1 mg, 2 mg, 2.5 mg, 3 mg, 4 mg, 5 mg, 6 mg, 7.5 mg, and/or 10 mg. For example, the minimum and maximum doses of several anticoagulant pill sizes are shown in Table 3.

Using the pill sizes, dosing ranges of the pill sizes, allocation patterns such as those described in Table 4 can be used to create a preselected list of doses ranging from a minimum dose to a maximum dose for the anticoagulant pill size. An allocation pattern may consist of a dose every day for the time period, or a pattern of alternating doses. Doses may be allocated on one or more days of the next time period. The dose may vary from one day to another. A daily dose may be ½ pill, 1 pill, 1½ pills, 2 pills or other specific dose. As a non-limiting example, the new dose may be allocated in any of the mnemonic patterns shown in Table 4, with an “X” indicating a first dose and an “O” indicating a second dose.

The preselected list of doses may also correspond to at least one mnemonic, e.g., a simple and/or repetitive pattern. The mnemonic may be simple to remember and may assist a patient in complying with the dosage schedule. For example, a mnemonic may be 7+0, 6+1, 3+4, 5+2, etc. As a non-limiting example, a preselected list of doses for several anticoagulant pill sizes ranging from a minimum dose to a maximum dose may be generated as shown in Tables 5-13.

The apparatus described herein may further comprise means for accepting another pill size other than the current anticoagulant pill size, e.g, if the determined new dose allocated for the next time period does not fall within the preselected list of doses ranging from a minimum dose to a maximum dose for the anticoagulant pill size, or if for any other reason another anticoagulant pill size is desired.

The means for providing the new allocated dose can be a printout, audible means, electronic means, any other means for conveying dose information, or any combination of means thereof. For instance, if the means for allocating a new dose is a printout, intended for the patient, the printout may contain, for example, pill size information, daily dosage for the next time period, and information as to how many pills to take daily (e.g., whether to take ½ a pill, 1 pill, 1½ pills, or 2 pills, or other specific dose). A printout may also contain other types of information, for example, the patient's name, medical history, physician information, date, clinic information, indications, instructions for taking the anticoagulant, side effects, contact information, warnings, cautions, or any other custom message.

The means for providing the new allocated dose may also be an audible means. For example, a device may be strapped to the patient that gives an audible signal daily at the time the anticoagulant should be taken. The audible signal may be, for example, a bell, a buzz, a ring, a ring tone, or a voice disclosing the name and amount of anticoagulant to take, or any other pertinent information. Alternatively, the means for providing the new allocated dose may be electronic. For example, the new allocated dose can be provided via email, website, computer, telephone, cell phone, text message, BlackBerry, Bluetooth, PDA, wireless device, or any other device that allows for electronic transmission.

In one embodiment, the apparatus for managing a patient's anticoagulation therapy is a point of care anticoagulation device. For example, a point of care anticoagulation device may provide anticoagulation assessment and management. The methods described herein may allow for consistent and safer patient monitoring when used in point of care anticoagulation devices, and allow for patient-focused anticoagulation care that includes reviews of anticoagulant compliance and side effects, medication and dietary changes, and disease-state management goals. The methods described herein and point of care anticoagulation devices can also be used by the patients or caregivers at home for testing for prothrombin time or INR. Use of the methods described herein with point of care management may allow a physician or other healthcare provider to avoid waiting for lab testing to be conducted and the results to be telephoned or mailed to the ordering office and to provide immediate anticoagulant dosing schedules to the patient.

The point of care anticoagulation device comprises, for example, means for measuring a patient's current prothrombin time or INR; means for accepting (a) the patient's cumulative dose of anticoagulant from a previous time period, (b) the patient's current INR, (c) an INR target, and (d) current anticoagulant pill size, into a series of equations; means for determining a new dose allocated for a next time period chosen from a preselected list of doses ranging from a minimum dose to a maximum dose for the anticoagulant pill size; and means for providing the new allocated dose. A physician, other healthcare provider, the patient, a caretaker, or anyone else can use a point of care device to provide anticoagulation assessment and management. The anticoagulation device may determine a patient's INR, for example, by testing the patient's whole blood for prothrombin time and calculating for INR. The device provides the patient's INR, along with the patient's cumulative dose of anticoagulant from a previous time period, an INR target, and current anticoagulant pill size, for example, into a series of equations. The device then outputs the patient's allocated dosing of anticoagulant for the next week. The physician or other healthcare provider then updates the patient's history of anticoagulant therapy and medical records. Alternatively, if the patient is performing the test himself, he can submit the results of the test to his physician or other healthcare provider for his medical records.

The anticoagulation device may use, for example, thromboplastin reagents packaged in strips or cuvettes similar to those used in blood glucose testing systems. The device may further include a sensor that prevents results from being reported if there is an error in sample collection timing, vibration or temperature extremes.

### Electronic Medical Records System

Disclosed herein are electronic medical records (EMR) systems. For example, an EMR system to keep track of patient medical information can be implemented at a healthcare provider facility. In one embodiment, the EMR system comprises a program for determining a patient's anticoagulant dosing allocated over a period of time, the program comprising: means for recording (a) the patient's cumulative dose of anticoagulant from a previous time period, (b) the patient's current INR, (c) an INR target, and (d) current anticoagulant pill size; means for accepting (a)-(d) into a series of equations; means for determining a new dose allocated for a next time period chosen from a preselected list of doses ranging from a minimum dose to a maximum dose for the anticoagulant pill size; and means for recording the new allocated dose.

Means for recording (a) the patient's cumulative dose of anticoagulant from a previous time period, (b) the patient's current INR, (c) an INR target, and (d) current anticoagulant pill size, into a series of equations include, for example, a computer program that provides a user interface, a downloaded software program, an email program, an interactive web-based program, an internet program, or any other type of computer or electronic program that allows for recording of information. If a computer program is used, such computer program can be written in any type of programming language, for example, Java, JavaScript, C++, Matlab, or any other programming language or code, preferably written so that it is interoperable with an EMR system. Other means for recording include, for example, manual device, a calculator, other electronic means, audible means, or any other means of recording information.

The anticoagulant may be any of the anticoagulants listed herein, or a combination of more than one anticoagulant. Preferably, the anticoagulant is warfarin or a warfarin derivative. The cumulative dose of anticoagulant may be calculated by, e.g., the total amount of anticoagulant taken over the previous time period, the sum of the amount of anticoagulant taken daily over the previous time period, or any other calculation that can be used to determine the patient's total anticoagulant intake over the previous time period. The previous time period from which a patient's cumulative dose is determined may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. Preferably, the time period is 1 week. The patient's current INR is, for example, the INR of the patient taken within approximately a 24 hour time period. An INR target may be from about 2.0 and about 3.0, about 2.1 and about 3.1, about 2.2 and about 3.2, about 2.3 and about 3.3, about 2.4 and about 3.4, between about 2.5 and about 3.5, between about 2.0 and about 4.0, or any other INR target between about 2.0 and about 4.0. The patient's current anticoagulant pill size is the pill size of anticoagulant that the patient is currently taking, or, alternatively, it may be any other pill size of anticoagulant. Other data points may be inputted into the series of equations, such as a patient's genetic factors, age, sex, diet, drug interactions, illness, and/or compliance with recommended dosing schedules, or any other information that may affect a patient's response to anticoagulant therapy.

Means for accepting (a) the patient's cumulative dose of anticoagulant from a previous time period, (b) the patient's current INR, (c) an INR target, and (d) current anticoagulant pill size, into a series of equations include, for example, a computer program that provides a user interface, a downloaded software program, an email program, an interactive web-based program, an internet program, or any other type of computer or electronic program. Other means for accepting include, for example, manual device, a calculator, other electronic means, audible means, or any other means of accepting information into a series of equations and calculating an output.

The series of equations into which the above data is entered may be any set of mathematical calculations designed to calculate a new dose of anticoagulant allocated for a next time period based on the patient's cumulative dose of anticoagulant from a previous time period. For example, for an INR target of 2.0 to 3.0, the series of equations may take the form of equations as illustrated in Table 1. For an INR target of 2.5 to 3.5, the series of equations may take the form of equations as illustrated in Table 2.

The EMR systems as described herein further comprise means for determining a new dose allocated for a next time period chosen from a preselected list of doses ranging from a minimum dose to a maximum dose for the anticoagulant pill size, based on the output calculated from the series of equations. The means for determining a new dose may include, for example, a computer program that can perform mathematical calculations and provide an output. Such a computer program can be written in any type of programming language, for example, Java, JavaScript, C++, Matlab, or any other programming language or code. Other means for allocating a new dose include, for example, manual, a calculator, other electronic means, or any other means for performing mathematical calculations and providing an output.

The allocated dose is expressed as a dose spread out over a time period. As a non limiting example, an allocated dose may be a daily dose given over a time period greater than one day. The next time period for which a new dose is allocated may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. The time period may be the same or different from the previous time period. Preferably, the time period is 1 week. The new dose may be allocated for the next time period chosen from a preselected list of doses ranging from a minimum dose to a maximum dose for the anticoagulant pill size. The anticoagulant pill size can be any commercially available pill size of anticoagulant or any other size of pill, e.g., 1 mg, 2 mg, 5 mg, or 7.5 mg. Preferably, when warfarin is the anticoagulant, the pill sizes used are 1 mg, 2 mg, 2.5 mg, 3 mg, 4 mg, 5 mg, 6 mg, 7.5 mg, and/or 10 mg. For example, the minimum and maximum doses of several anticoagulant pill sizes are shown in Table 3.

Using the pill sizes, dosing ranges of the pill sizes, allocation patterns such as those described in Table 4 can be used to create a preselected list of doses ranging from a minimum dose to a maximum dose for the anticoagulant pill size. An allocation pattern may consist of a dose every day for the time period, or a pattern of alternating doses. Doses may be allocated on one or more days of the next time period. The dose may vary from one day to another. A daily dose may be ½ pill, 1 pill, 1½ pills, 2 pills or other specific dose. As a non-limiting example, the new dose may be allocated in any of the mnemonic patterns shown in Table 4, with an “X” indicating a first dose and an “O” indicating a second dose.

The preselected list of doses may also correspond to at least one mnemonic, e.g., a simple and/or repetitive pattern. The mnemonic may be simple to remember and may assist a patient in complying with the dosage schedule. For example, a mnemonic may be 7+0, 6+1, 3+4, 5+2, etc. As a non-limiting example, a preselected list of doses for several anticoagulant pill sizes ranging from a minimum dose to a maximum dose may be generated as shown in Tables 5-13.

The EMR systems described herein may further comprise means for accepting another pill size other than the current anticoagulant pill size, e.g, if the determined new dose allocated for the next time period does not fall within the preselected list of doses ranging from a minimum dose to a maximum dose for the anticoagulant pill size, or if for any other reason another anticoagulant pill size is desired.

The EMR systems may also further include means for recording the patient's new allocated dose into the EMR system. The means for recording the new allocated dose may be for example, a computer program that provides a user interface, a downloaded software program, an email program, an interactive web-based program, an internet program, or any other type of computer or electronic program that allows for recording of information. If a computer program is used, such computer program can be written in any type of programming language, for example, Java, JavaScript, C++, Matlab, or any other programming language or code, preferably written so that it is interoperable with an EMR system. Other means for recording include, for example, manual device, a calculator, other electronic means, audible means, or any other means of recording information. The means for recording may also record the patient's cumulative dose of anticoagulant from the previous week, the patient's current INR, an INR target, and current anticoagulant pill size. Those with access to the patient's EMR can thus access the program and also determine the patient's current and past dosages of anticoagulants. Other relevant information to anticoagulation such as the patient's genetic factors, age, sex, diet, drug interactions, illness, and patient compliance with recommended dosing schedules can also be integrated in the program in the EMR system. A physician may assess the patient's progress on anticoagulant therapy by viewing the past dosing schedules, INR, and other information available on the EMR system.

The EMR system may also allows a physician to prepare prescription information for the patient's allotted dosage of anticoagulant, for example. Further, a pharmacy may also be connected to the EMR system to access a patient's prescription information and history. For example, a pharmacist may electronically pull up a patient's anticoagulant prescription record from the database.

### Clinical Decision Support Program

Described herein are clinical decision support programs for determining a new dose of anticoagulant allocated over a period of time. A physician or other healthcare provider may utilize such a clinical decision support program as a basis for prescribing anticoagulant to a patient, as a consistent management guideline to use for patients or across patients, as a guideline to check recommended dosing levels, to assist in achieving therapeutic anticoagulation levels, and/or to decrease the number of treatment failures and adverse events, to name a few.

For example, the program may comprise means for accepting (a) the patient's cumulative dose of anticoagulant from a previous time period, (b) the patient's current INR, (c) an INR target, and (d) current anticoagulant pill size, into a series of equations; means for determining a new dose allocated for a next time period, chosen from a preselected list of doses ranging from a minimum dose to a maximum dose for the anticoagulant pill size; and means for providing the new allocated dose. Generally, a physician or other healthcare provider may input a patient's cumulative dose of anticoagulant from a previous time period, the patient's current INR, an INR target, and current anticoagulant pill size into the program. The physician or other healthcare provider then uses the allocated new dose generated by the clinical decision support program to determine the appropriate allocated new dose for the patient.

Means for accepting (a) the patient's cumulative dose of anticoagulant from a previous time period, (b) the patient's current INR, (c) an INR target, and (d) current anticoagulant pill size, into a series of equations include, for example, a computer program that provides a user interface, a downloaded software program, an email program, an interactive web-based program, an internet program, or any other type of computer or electronic program. Other means for accepting include, for example, manual device, a calculator, other electronic means, audible means, or any other means of accepting information into a series of equations and calculating an output. The means for accepting may be a stand alone means or may be means integrated into a system, for example, an electronic medical records system, or may feed into a central database, for example, to link separate clinics and create a virtual anticoagulation clinic.

The anticoagulant may be any of the anticoagulants listed herein, or a combination of more than one anticoagulant. Preferably, the anticoagulant is warfarin or a warfarin derivative. The cumulative dose of anticoagulant may be calculated by, e.g., the total amount of anticoagulant taken over the previous time period, the sum of the amount of anticoagulant taken daily over the previous time period, or any other calculation that can be used to determine the patient's total anticoagulant intake over the previous time period. The previous time period from which a patient's cumulative dose is determined may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. Preferably, the time period is 1 week. The patient's current INR is, for example, the INR of the patient taken within approximately a 24 hour time period. An INR target may be from about 2.0 and about 3.0, about 2.1 and about 3.1, about 2.2 and about 3.2, about 2.3 and about 3.3, about 2.4 and about 3.4, between about 2.5 and about 3.5, between about 2.0 and about 4.0, or any other INR target between about 2.0 and about 4.0. The patient's current anticoagulant pill size is the pill size of anticoagulant that the patient is currently taking, or, alternatively, it may be any other pill size of anticoagulant. Other data points may be inputted into the series of equations, such as a patient's genetic factors, age, sex, diet, drug interactions, illness, and/or compliance with recommended dosing schedules, or any other information that may affect a patient's response to anticoagulant therapy.

The series of equations into which the above data is entered may be any set of mathematical calculations designed to calculate a new dose of anticoagulant allocated for a next time period based on the patient's cumulative dose of anticoagulant from a previous time period. For example, for an INR target of 2.0 to 3.0, the series of equations may take the form of equations as illustrated in Table 1. For an INR target of 2.5 to 3.5, the series of equations may take the form of equations as illustrated in Table 2.

The clinical decision support program as described herein further comprise means for determining a new dose allocated for a next time period chosen from a preselected list of doses ranging from a minimum dose to a maximum dose for the anticoagulant pill size, based on the output calculated from the series of equations. The means for determining a new dose may include, for example, a computer program that can perform mathematical calculations and provide an output. Such a computer program can be written in any type of programming language, for example, Java, JavaScript, C++, Matlab, or any other programming language or code. Other means for allocating a new dose include, for example, manual, a calculator, other electronic means, or any other means for performing mathematical calculations and providing an output.

The allocated dose is expressed as a dose spread out over a time period. As a non limiting example, an allocated dose may be a daily dose given over a time period greater than one day. The next time period for which a new dose is allocated may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. The time period may be the same or different from the previous time period. Preferably, the time period is 1 week. The new dose may be allocated for the next time period chosen from a preselected list of doses ranging from a minimum dose to a maximum dose for the anticoagulant pill size. The anticoagulant pill size can be any commercially available pill size of anticoagulant or any other size of pill, e.g., 1 mg, 2 mg, 5 mg, or 7.5 mg. Preferably, when warfarin is the anticoagulant, the pill sizes used are 1 mg, 2 mg, 2.5 mg, 3 mg, 4 mg, 5 mg, 6 mg, 7.5 mg, and/or 10 mg. For example, the minimum and maximum doses of several anticoagulant pill sizes are shown in Table 3.

Using the pill sizes, dosing ranges of the pill sizes, allocation patterns such as those described in Table 4 can be used to create a preselected list of doses ranging from a minimum dose to a maximum dose for the anticoagulant pill size. An allocation pattern may consist of a dose every day for the time period, or a pattern of alternating doses. Doses may be allocated on one or more days of the next time period. The dose may vary from one day to another. A daily dose may be ½ pill, 1 pill, 1½ pills, 2 pills or other specific dose. As a non-limiting example, the new dose may be allocated in any of the mnemonic patterns shown in Table 4, with an “X” indicating a first dose and an “O” indicating a second dose.

The preselected list of doses may also correspond to at least one mnemonic, e.g., a simple and/or repetitive pattern. The mnemonic may be simple to remember and may assist a patient in complying with the dosage schedule. For example, a mnemonic may be 7+0, 6+1, 3+4, 5+2, etc. As a non-limiting example, a preselected list of doses for several anticoagulant pill sizes ranging from a minimum dose to a maximum dose may be generated as shown in Tables 5-13.

The clinical decision support programs described herein may further comprise means for accepting another pill size other than the current anticoagulant pill size, e.g, if the determined new dose allocated for the next time period does not fall within the preselected list of doses ranging from a minimum dose to a maximum dose for the anticoagulant pill size, or if for any other reason another anticoagulant pill size is desired.

The means for providing the new allocated dose can be a printout, audible means, electronic means, any other means for conveying dose information, or any combination of means thereof. For instance, if the means for allocating a new dose is a printout, intended for the patient, the printout may contain, for example, pill size information, daily dosage for the next time period, and information as to how many pills to take daily (e.g., whether to take ½ a pill, 1 pill, 1½ pills, or 2 pills, or other specific dose). A printout may also contain other types of information, for example, the patient's name, medical history, physician information, date, clinic information, indications, instructions for taking the anticoagulant, side effects, contact information, warnings, cautions, or any other custom message.

The means for providing the new allocated dose may also be an audible means. For example, a device may be strapped to the patient that gives an audible signal daily at the time the anticoagulant should be taken. The audible signal may be, for example, a bell, a buzz, a ring, a ring tone, or a voice disclosing the name and amount of anticoagulant to take, or any other pertinent information. Alternatively, the means for providing the new allocated dose may be electronic. For example, the new allocated dose can be provided via email, website, computer, telephone, cell phone, text message, BlackBerry, Bluetooth, PDA, wireless device, or any other device that allows for electronic transmission.

Once a patient has taken the new allocated dose for the next time period and the next time period (or multiple thereof) has expired, the patient may return to his or her physician or other healthcare provider to obtain a new allocated dose for a next time period, using the methods for management of anticoagulation therapy described herein or any other methods. The methods can be repeated after consecutive time periods as desired.

The clinical decision support programs for management of anticoagulation therapy as described herein can also be implemented in conjunction with other clinical decision support programs for management of other therapies. The clinical decision support programs may also allow a physician to prepare prescription information for the patient's allotted dosage of anticoagulant.

### Virtual Anticoagulation Clinic

Described herein are virtual anticoagulation clinics for management of a patient's anticoagulant therapy. For example, various clinics may call up a program when a patient desires anticoagulation therapy. Individual clinics may all use a common, linked program that stores the data in a central database. The virtual anticoagulation clinic allows for rapid dose calculations and adjustments and suggests new dose schedules that enhance patient compliance. A physician or other healthcare provider may utilize such a virtual anticoagulation clinic as a basis for prescribing anticoagulant to a patient, as a consistent management guideline to use for patients or across patients, as a guideline to check recommended dosing levels, to assist in achieving therapeutic anticoagulation levels, and/or to decrease the number of treatment failures and adverse events, to name a few. The central database also may allow a physician to prepare prescription information for the patient's allotted dosage of anticoagulant.

For example, a virtual anticoagulation clinic may comprise means for accepting (a) the patient's cumulative dose of anticoagulant from a previous time period, (b) the patient's current INR, (c) an INR target, and (d) current anticoagulant pill size, into a series of equations; means for determining a new dose allocated for a next time period selected from a predetermined list of doses using a mnemonic for compliance; and means for providing the new allocated dose.

Means for accepting (a) the patient's cumulative dose of anticoagulant from a previous time period, (b) the patient's current INR, (c) an INR target, and (d) current anticoagulant pill size, into a series of equations include, for example, a computer program that provides a user interface, a downloaded software program, an email program, an interactive web-based program, an internet program, or any other type of computer or electronic program. Other means for accepting include, for example, manual device, a calculator, other electronic means, audible means, or any other means of accepting information into a series of equations and calculating an output. The means for accepting may feed into a central database, for example, to link separate clinics and create a virtual anticoagulation clinic.

The anticoagulant may be any of the anticoagulants listed herein, or a combination of more than one anticoagulant. Preferably, the anticoagulant is warfarin or a warfarin derivative. The cumulative dose of anticoagulant may be calculated by, e.g., the total amount of anticoagulant taken over the previous time period, the sum of the amount of anticoagulant taken daily over the previous time period, or any other calculation that can be used to determine the patient's total anticoagulant intake over the previous time period. The previous time period from which a patient's cumulative dose is determined may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. Preferably, the time period is 1 week. The patient's current INR is, for example, the INR of the patient taken within approximately a 24 hour time period. An INR target may be from about 2.0 and about 3.0, about 2.1 and about 3.1, about 2.2 and about 3.2, about 2.3 and about 3.3, about 2.4 and about 3.4, between about 2.5 and about 3.5, between about 2.0 and about 4.0, or any other INR target between about 2.0 and about 4.0. The patient's current anticoagulant pill size is the pill size of anticoagulant that the patient is currently taking, or, alternatively, it may be any other pill size of anticoagulant. Other data points may be inputted into the series of equations, such as a patient's genetic factors, age, sex, diet, drug interactions, illness, and/or compliance with recommended dosing schedules, or any other information that may affect a patient's response to anticoagulant therapy.

The series of equations into which the above data is entered may be any set of mathematical calculations designed to calculate a new dose of anticoagulant allocated for a next time period based on the patient's cumulative dose of anticoagulant from a previous time period. For example, for an INR target of 2.0 to 3.0, the series of equations may take the form of equations as illustrated in Table 1. For an INR target of 2.5 to 3.5, the series of equations may take the form of equations as illustrated in Table 2.

The virtual anticoagulation clinic as described herein further comprise means for determining a new dose allocated for a next time period chosen from a preselected list of doses ranging from a minimum dose to a maximum dose for the anticoagulant pill size, based on the output calculated from the series of equations. The means for determining a new dose may include, for example, a computer program that can perform mathematical calculations and provide an output. Such a computer program can be written in any type of programming language, for example, Java, JavaScript, C++, Matlab, or any other programming language or code. Other means for allocating a new dose include, for example, manual, a calculator, other electronic means, or any other means for performing mathematical calculations and providing an output.

The allocated dose is expressed as a dose spread out over a time period. As a non limiting example, an allocated dose may be a daily dose given over a time period greater than one day. The next time period for which a new dose is allocated may be about one day, about two days, about three days, about four days, about five days, about six days, about seven days, about 2 weeks, about 3 weeks, about 4 weeks, about 5 weeks, about 6 weeks, about 7 weeks, about 8 weeks, or any other time period in between one day and 8 weeks. The time period may be the same or different from the previous time period. Preferably, the time period is 1 week. The new dose may be allocated for the next time period chosen from a preselected list of doses ranging from a minimum dose to a maximum dose for the anticoagulant pill size. The anticoagulant pill size can be any commercially available pill size of anticoagulant or any other size of pill, e.g., 1 mg, 2 mg, 5 mg, or 7.5 mg. Preferably, when warfarin is the anticoagulant, the pill sizes used are 1 mg, 2 mg, 2.5 mg, 3 mg, 4 mg, 5 mg, 6 mg, 7.5 mg, and/or 10 mg. For example, the minimum and maximum doses of several anticoagulant pill sizes are shown in Table 3.

Using the pill sizes, dosing ranges of the pill sizes, allocation patterns such as those described in Table 4 can be used to create a preselected list of doses ranging from a minimum dose to a maximum dose for the anticoagulant pill size. An allocation pattern may consist of a dose every day for the time period, or a pattern of alternating doses. Doses may be allocated on one or more days of the next time period. The dose may vary from one day to another. A daily dose may be ½ pill, 1 pill, 1½ pills, 2 pills or other specific dose. As a non-limiting example, the new dose may be allocated in any of the mnemonic patterns shown in Table 4, with an “X” indicating a first dose and an “O” indicating a second dose.

The preselected list of doses may also correspond to at least one mnemonic, e.g., a simple and/or repetitive pattern. The mnemonic may be simple to remember and may assist a patient in complying with the dosage schedule. For example, a mnemonic may be 7+0, 6+1, 3+4, 5+2, etc. As a non-limiting example, a preselected list of doses for several anticoagulant pill sizes ranging from a minimum dose to a maximum dose may be generated as shown in Tables 5-13.

The virtual anticoagulation clinics described herein may further comprise means for accepting another pill size other than the current anticoagulant pill size, e.g, if the determined new dose allocated for the next time period does not fall within the preselected list of doses ranging from a minimum dose to a maximum dose for the anticoagulant pill size, or if for any other reason another anticoagulant pill size is desired.

The means for providing the new allocated dose can be a printout, audible means, electronic means, any other means for conveying dose information, or any combination of means thereof. For instance, if the means for allocating a new dose is a printout, intended for the patient, the printout may contain, for example, pill size information, daily dosage for the next time period, and information as to how many pills to take daily (e.g., whether to take ½ a pill, 1 pill, 1½ pills, or 2 pills, or other specific dose). A printout may also contain other types of information, for example, the patient's name, medical history, physician information, date, clinic information, indications, instructions for taking the anticoagulant, side effects, contact information, warnings, cautions, or any other custom message.

The means for providing the new allocated dose may also be an audible means. For example, a device may be strapped to the patient that gives an audible signal daily at the time the anticoagulant should be taken. The audible signal may be, for example, a bell, a buzz, a ring, a ring tone, or a voice disclosing the name and amount of anticoagulant to take, or any other pertinent information. Alternatively, the means for providing the new allocated dose may be electronic. For example, the new allocated dose can be provided via email, website, computer, telephone, cell phone, text message, BlackBerry, Bluetooth, PDA, wireless device, or any other device that allows for electronic transmission.

Once a patient has taken the new allocated dose for the next time period and the next time period (or multiple thereof) has expired, the patient may return to his or her physician or other healthcare provider to obtain a new allocated dose for a next time period, using the methods for management of anticoagulation therapy described herein or any other methods. The methods can be repeated after consecutive time periods as desired.

### EXAMPLES

### Example 1

### Program for Management of Anticoagulation Therapy

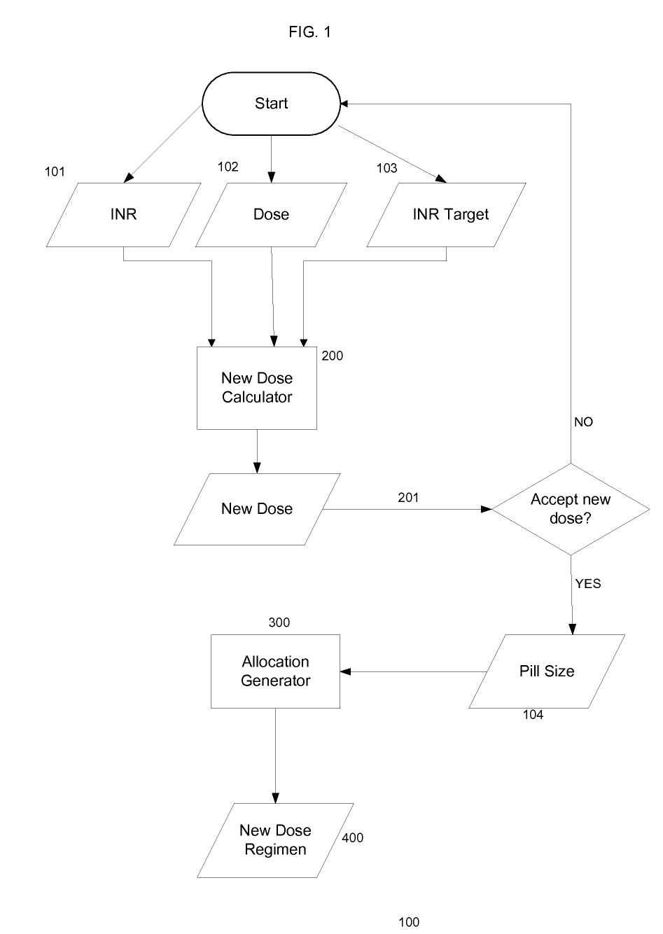

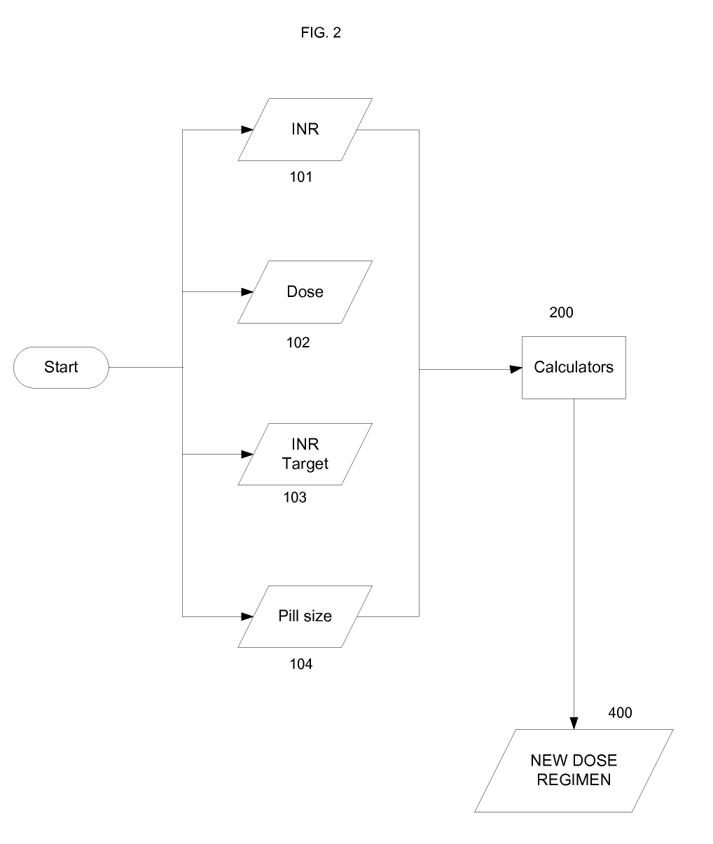

A program (100) for management of anticoagulation therapy was developed (FIG. 1). The program required input of four data points: INR value (for a current blood sample) (101); dose (of warfarin from the previous week) (102); INR target for treatment (either 2.0 to 3.0 or 2.5 to 3.5) (103); and pill size (104) (FIG. 2). Data points 101-104 were input into calculators 200 to produce a new dose regimen (400). More specifically, the program (100) accepted data points 101-103 into new dose calculator (200) to calculate a new dose (201). The new dose (201) along with pill size (104) was then sent to the Allocation Generator (300) to produce new dose regimen (400).

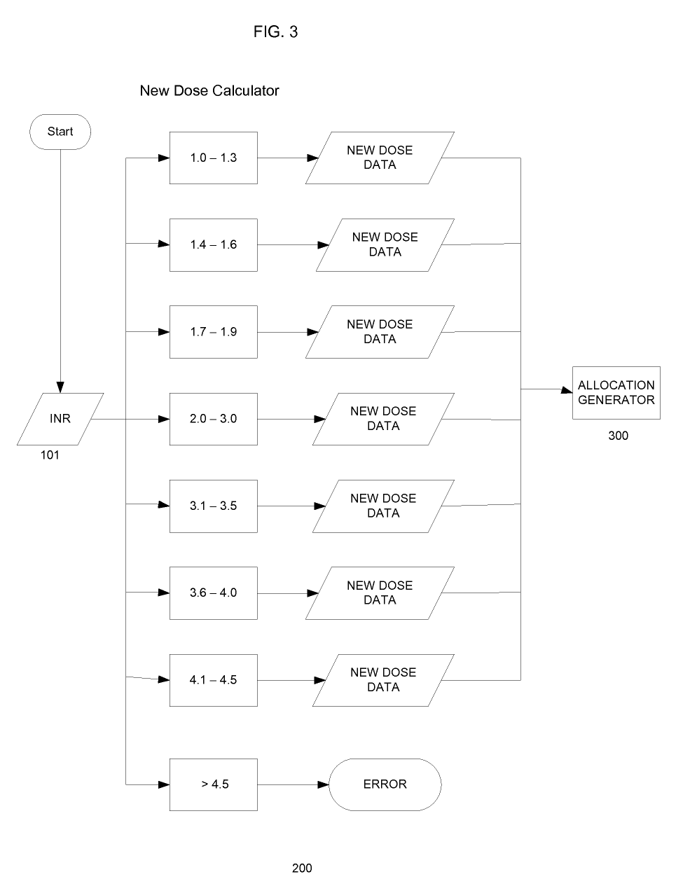

A new dose was generated by the new dose calculator (200) (FIG. 3). The new dose calculator sorted the INR reading (101) into an appropriate category 1.0-1.3, 1.4-1.6, 1.7-1.9, 2.0-3.0, 3.1-3.5, 3.6-4.0, 4.1-4.5, and >4.5. Based on the category of INR, and the INR target, new dose data was calculated and sent to the Allocation Generator (300) to create a new dose regimen.

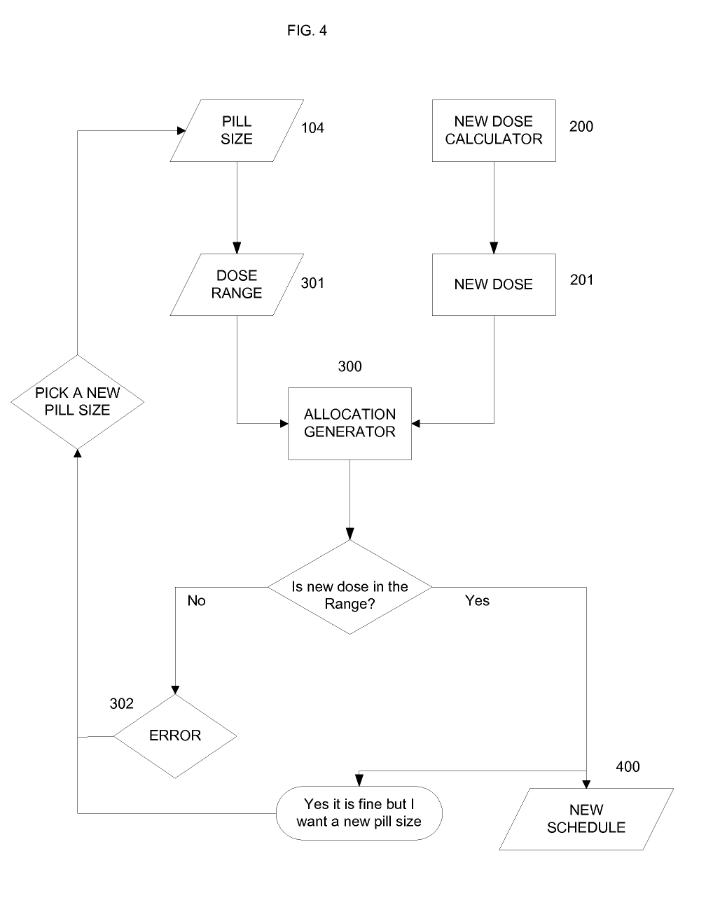

The Allocation Generator (300) (FIG. 4) received a new dose (201) from the new dose calculator (200) and also calculates a dose range (301) based on the pill size (104) inputted. The Allocation Generator (300) used the data from the new dose calculator (200) along with the inputted pill size (104) to determine a new dosing schedule via one of four allocation patterns (Table 3). The dose range (301) extended from the minimum possible dose to the maximum possible dose for the pill size (104) inputted. The Allocation Generator then determined whether the new dose (201) was within the dose range (301). The Allocation Generator first verified the pill size, and then searched through all of the possible doses of that pill size to determine whether the new cumulative dose was practical, within the constraints of the values shown in Table 4. If the Allocation Generator found a value in the range, it selected the allocation pattern that matched the pill sized selected, according to the Dose Allocation Schedule for the pill size (Tables 5-13) and provided a new allocated dose schedule (400). If the Allocation Generator did not find a value in the range, an error message (302) was generated, indicating that no appropriate dose was on the database, and advised a new pill size selection having a value in the range.

The allocation patterns were intended to serve as a mnemonic, where A is daily; B is all days except for 1 different day; C is 3 days on one dose, 4 days on a second dose; and D is 5 days on one does, 2 days on a second dose.

Using the nine different pill sizes of warfarin commercially available, a maximal practical dose and minimal low dose of warfarin was calculated (Table 4), along with all possible doses within the range of cumulative doses, and a practical range of dosing for each pill size (Tables 5-13) according to the mnemonics chosen. An arbitrary assumption was made that each pill was taken as a whole pill, a half pill, or two pills a day. With these assumptions, 28 possible doses were calculated for each available pill size of warfarin. With nine different pill sizes, there were 252 potential doses within the practical dosing ranges. The potential doses ranged from 0.5 mg a week to 140 mg a week in half-milligram intervals. These allocation patterns were chosen as the least complicated to decrease the potential for error.

### Example 2

### Interface for Program for Anticoagulant Therapy

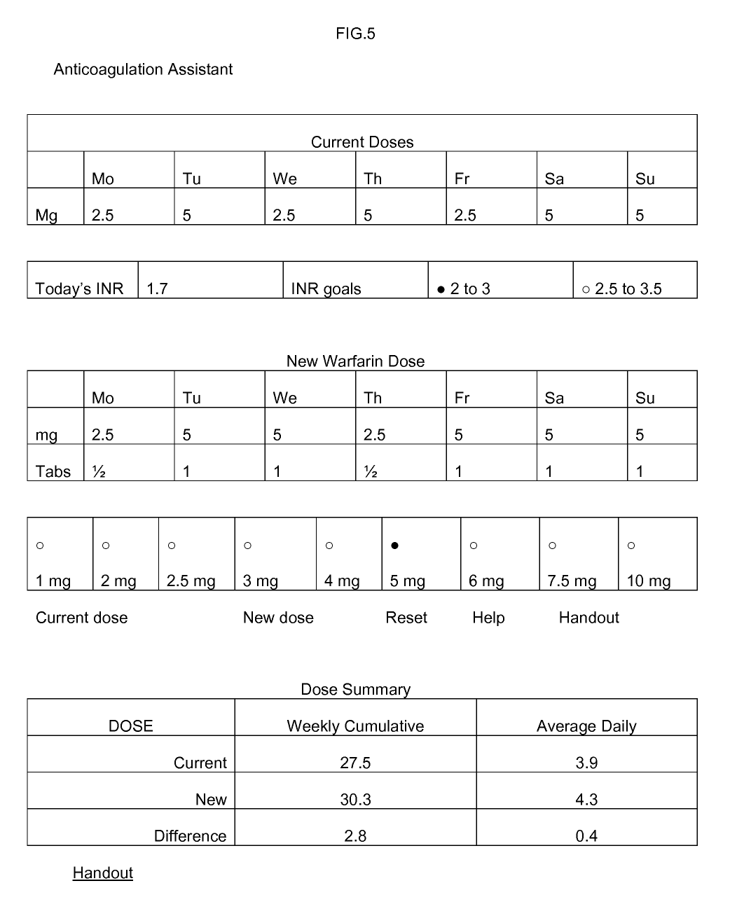

An interface for a program for anticoagulant therapy as described in Example 1 was created (FIG. 5). The interface was called up on a computer as a web page by entering in a URL. The program was embedded in the web page. Data was entered by typing into the boxes on the interface. In the first row, daily doses for the previous week were entered. In the second row, the current INR and INR goal were entered. In the fourth row, the pill size was entered. The colors of the boxes for pill sizes correspond to the colors of the respective warfarin pills.

The calculations were performed by pressing the buttons on the interface. The “current dose” button calculated the weekly cumulative dose and average daily dose. The “new dose” button calculated the new recommended dose, and the difference between the old dose and new recommended dose. The new warfarin dose was displayed after pressing the “new dose” calculation button, and provided the recommended dose for the pill size that was chosen in the pill size selector. A user who desired to change the pill size clicked on a different pill size in the selector. Once a new pill size was selected and the “new dose” button pressed, a new dose recommendation was calculated in the “new dose” box.

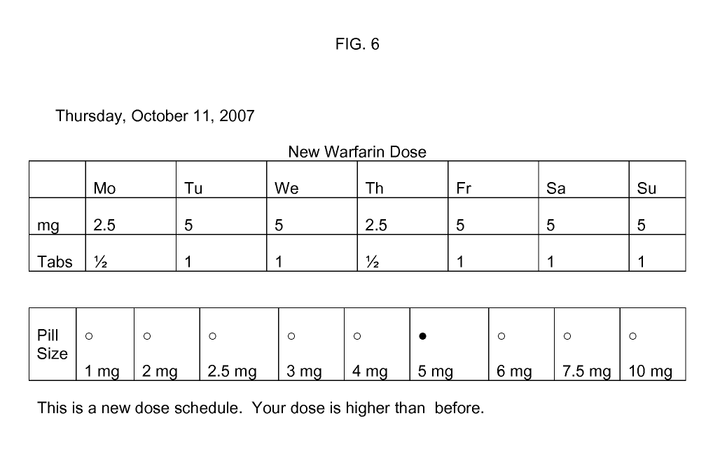

The “handout” button produced a patient printout with the new warfarin dose (FIG. 6). The printout was printed with the following information: new warfarin dose, pill size, and a custom message.

### Example 3

### Clinical Management of Warfarin Dosing

A. S. is a 78-year-old white woman with atrial fibrillation. A. S. started on warfarin and after stabilization of her dose, her Protime/INR was checked once a month. On the first day, her INR was 1.6. Her warfarin dose was 4 mg on Mondays, Wednesdays, and Fridays and 2 mg on the remaining days of the week. Her INR, dose for the previous week, INR target, and pill size were inputted into the program described in Example 1. The program calculated A. S.'s new dose, which was 4 mg to be taken 6 days a week and 2 mg on Saturday. A. S.'s INR was taken 2 weeks later and was 2.8, within the target range.

### Example 4

### Electronic Medical Records System with Management of Anticoagulant Therapy

An electronic medical record (EMR) system to keep track of patient medical information is implemented at a healthcare provider. The EMR system is integrated with a program for management of anticoagulant therapy as described in Example 1. The program records the patient's cumulative dose of anticoagulant from the previous week, the patient's current INR, an INR target, and current warfarin pill size, and outputs a new dose for the patient for the following week using an appropriate allocation pattern. The weekly dosage is stored in the patient's EMR. Those with access to the patient's EMR can thus access the program and also determine the patient's current and past dosages of anticoagulants. Other relevant information to anticoagulation such as the patient's genetic factors, age, sex, diet, drug interactions, illness, and patient compliance with recommended dosing schedules are integrated in the program in the EMR system. A physician may assess the patient's progress on anticoagulant therapy by viewing the past dosing schedules on the EMR system.

The EMR system also allows a physician to prepare prescription information for the patient's allotted dosage of anticoagulant.

### Example 5

### Clinical Decision Support Program for Management of Anticoagulation Therapy

A clinical decision support program for management of anticoagulation therapy is implemented at a healthcare provider. The program implemented is as described in Example 1. A physician or other healthcare provider inputs a patient's cumulative dose of warfarin from the previous week, the patient's current INR, an INR target, and current warfarin pill size into the program. The physician or other healthcare provider then uses the allocated new dose generated by the clinical decision support program to determine the appropriate allocated new dose for the patient. The clinical decision support program for management of anticoagulation therapy can also be implemented in conjunction with other clinical decision support programs for management of other therapies.

The clinical decision support program also allows a physician to prepare prescription information for the patient's allotted dosage of anticoagulant.

A pharmacy is also connected to the central database so that a patient's prescription information and history are accessible. A pharmacist electronically pulls up a patient's anticoagulant prescription record from the database.

### Example 6

### Virtual Anticoagulation Clinic

A virtual anticoagulation clinic is created using the program described in Example 1. Various clinics call up the program using the interface described in Example 2 when a patient desires anticoagulation therapy. The patient's previous weekly dosage, current INR, INR target, and anticoagulant pill size are entered and an allocated new dose is generated. The individual clinics all use the common interface which stores the data in a central database. The program allows for rapid dose calculations and adjustments and suggest new dose schedules that enhance patient compliance. The central database also allows a physician to prepare prescription information for the patient's allotted dosage of anticoagulant.

A pharmacy is also connected to the central database so that a patient's prescription information and history are accessible. A pharmacist electronically pulls up a patient's anticoagulant prescription record from the database.

### Example 7

### Anticoagulation Point of Care Management

A point of care anticoagulation device is constructed implementing the program described in Example 1. A physician or other healthcare provider uses the point of care anticoagulation device to provide anticoagulation assessment and warfarin management. A physician, other healthcare provider, or the patient himself can use a point of care device such as CoaguChek or ProTime, to test the patient's whole blood for prothrombin time/INR. The device uses thromboplastin reagents packaged in strips or cuvettes similar to those used in blood glucose testing systems. The device has a sensor that prevents results from being reported if there is an error in sample collection timing, vibration or temperature extremes. The device provides the patient's current INR which is inputted into the program described in Example 1. The device then outputs the patient's allocated dosing of warfarin for the next week. The physician or other healthcare provider then updates the patient's history of anticoagulant therapy and medical records. Alternatively, if the patient is performing the test himself, he can submit the results of the test to his physician or other healthcare provider for his medical records. The patient then complies with the recommended warfarin dose schedule for the next week.

While the inventions herein have been particularly shown and described with references to the disclosed embodiments, it will be understood by those skilled in the art that various changes in form and details may be made therein without departing from the scope of the invention encompassed by the appended claims.

What is claimed is:

1. A method for managing a patient's anticoagulation therapy comprising:
inputting (a) the patient's cumulative dose of anticoagulant from a previous time period, (b) the patient's current INR, (c) an INR target, and (d) current anticoagulant pill size, into a series of equations;
determining a new dose allocated for a next time period, chosen from a preselected list of doses ranging from a minimum dose to a maximum dose for the anticoagulant pill size; and
providing the new allocated dose.

2. The method of claim 1, wherein the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

3. The method of claim 1, wherein the INR target is about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

4. The method of claim 1, wherein the anticoagulant is warfarin.

5. The method of claim 1, wherein the preselected list of doses corresponds to at least one mnemonic.

6. The method of claim 1, wherein the previous time period and the next time period are one week.

7. The method of claim 1, further comprising inputting another anticoagulant pill size other than the current anticoagulant pill size before providing the new allocated dose.

8. The method of claim 1, wherein the new dose is therapeutically effective.

9. The method of claim 1, wherein the new dose is provided on a printout, by audible means, by electronic means, or any combination thereof.

10. The method of claim 1, further comprising inputting the patient's genetic factors, age, sex, diet, drug interactions, illness, or patient compliance with prior dosing schedules, or any combination thereof, into the series of equations.

11. An apparatus for managing a patient's anticoagulation therapy comprising:
means for accepting (a) the patient's cumulative dose of anticoagulant from a previous time period, (b) the patient's current INR, (c) an INR target, and (d) current anticoagulant pill size, into a series of equations;
means for determining a new dose allocated for a next time period, chosen from a preselected list of doses ranging from a minimum dose to a maximum dose for the anticoagulant pill size; and
means for providing the new allocated dose.

12. The apparatus of claim 11, wherein the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

13. The apparatus of claim 11, wherein the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

14. The apparatus of claim 11, wherein the anticoagulant is warfarin.

15. The apparatus of claim 11, wherein the preselected list of doses corresponds to at least one mnemonic.

16. The apparatus of claim 11, wherein the previous time period and the next time period are one week.

17. The apparatus of claim 11, further comprising means for accepting another anticoagulant pill size other than the current anticoagulant pill size.

18. The apparatus of claim 11, wherein the means for providing the new allocated dose is a printout, is audible, is electronic, or any combination thereof.

19. The apparatus of claim 11, further comprising means for accepting the patient's genetic factors, age, sex, diet, drug interactions, illness, or patient compliance with prior dosing schedules, or any combination thereof, into the series of equations.

20. An electronic medical records system comprising a program for managing a patient's anticoagulation therapy, the program comprising:
means for recording (a) the patient's cumulative dose of anticoagulant from a previous time period, (b) the patient's current INR, (c) an INR target, and (d) current anticoagulant pill size;
means for accepting (a)-(d) into a series of equations;
means for determining a new dose allocated for a next time period, chosen from a preselected list of doses ranging from a minimum dose to a maximum dose for the anticoagulant pill size; and
means for recording the new allocated dose.

21. The electronic medical records system of claim 20, wherein the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

22. The electronic medical records system of claim 20, wherein the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

23. The electronic medical records system of claim 20, wherein the anticoagulant is warfarin.

24. The electronic medical records system of claim 20, wherein the preselected list of doses corresponds to at least one mnemonic.

25. The electronic medical records system of claim 20, wherein the previous time period and the next time period are one week.

26. The electronic medical records system of claim 20, further comprising means for accepting another anticoagulant pill size other than the current anticoagulant pill size.

27. A clinical decision support program for managing a patient's anticoagulation therapy, the program comprising:
means for accepting (a) the patient's cumulative dose of anticoagulant from a previous time period, (b) the patient's current INR, (c) an INR target, and (d) current anticoagulant pill size, into a series of equations;
means for determining a new dose allocated for a next time period, chosen from a preselected list of doses ranging from a minimum dose to a maximum dose for the anticoagulant pill size; and
means for providing the new allocated dose.

28. The clinical decision support program of claim 27, wherein the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

29. The clinical decision support program of claim 27, wherein the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

30. The clinical decision support program of claim 27, wherein the anticoagulant is warfarin.

31. The clinical decision support program of claim 27, wherein the preselected list of doses corresponds to at least one mnemonic.

32. The clinical decision support program of claim 27, wherein the previous time period and the next time period are one week.

33. The clinical decision support program of claim 27, further comprising means for accepting another anticoagulant pill size other than the current anticoagulant pill size.

34. A virtual anticoagulation clinic comprising:
means for accepting (a) the patient's cumulative dose of anticoagulant from a previous time period, (b) the patient's current INR, (c) an INR target, and (d) current anticoagulant pill size, into a series of equations;
means for determining a new dose allocated for a next time period, chosen from a preselected list of doses ranging from a minimum dose to a maximum dose for the anticoagulant pill size; and
means for providing the new allocated dose.

35. The virtual anticoagulation clinic of claim 34, wherein the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

36. The virtual anticoagulation clinic of claim 34, wherein the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

37. The virtual anticoagulation clinic of claim 34, wherein the anticoagulant is warfarin.

38. The virtual anticoagulation clinic of claim 34, wherein the preselected list of doses corresponds to at least one mnemonic.

39. The virtual anticoagulation clinic of claim 34, wherein the previous time period and the next time period are one week.

40. The virtual anticoagulation clinic of claim 34, further comprising accepting another anticoagulant pill size other than the current anticoagulant pill size before providing the new allocated dose.

41. A point of care anticoagulation device for management of a patient's anticoagulant therapy comprising:
means for measuring the patient's current prothrombin time or INR;
means for accepting (a) the patient's cumulative dose of anticoagulant from a previous time period, (b) the patient's current INR, (c) an INR target, and (d) current anticoagulant pill size, into a series of equations;
means for determining a new dose allocated for a next time period, chosen from a preselected list of doses ranging from a minimum dose to a maximum dose for the anticoagulant pill size; and
means for providing the new allocated dose.

42. The device of claim 41, wherein the INR target is from about 2.0 to about 3.0 and the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

wherein N is the new dose and C is the previous cumulative weekly dose.

43. The device of claim 41, wherein the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

wherein N is the new dose and C is the previous cumulative weekly dose.

44. The device of claim 41, wherein the anticoagulant is warfarin.

45. The device of claim 41, wherein the preselected list of doses corresponds to at least one mnemonic.

46. The device of claim 41, wherein the previous time period and the next time period are one week.

47. The device of claim 41, further comprising means for accepting another anticoagulant pill size other than the current anticoagulant pill size.

48. A method for managing a patient's warfarin therapy comprising:
inputting (a) the patient's cumulative dose of warfarin from the previous week, (b) the patient's current INR, (c) an INR target, and (d) current warfarin pill size, into a series of equations;
determining a new dose allocated for the next week, chosen from a preselected list of doses ranging from a minimum dose to a maximum dose for the warfarin pill size;
inputting another warfarin pill size into the series of equations if desired and determining a new dose allocated for the next week chosen from a preselected list of doses ranging from a minimum dose to a maximum dose for the new warfarin pill size; and
providing the new allocated dose;
wherein when the INR target is from about 2.0 to about 3.0 the series of equations is:

| INR | Equation |
|---|---|
| 1.0-1.3 | N = 1.2C |
| 1.4-1.6 | N = 1.15C |
| 1.7-1.9 | N = 1.1C |
| 2.0-3.0 | N = C |
| 3.1-3.5 | N = 0.95C |
| 3.6-4.0 | N = 0.9C |
| 4.0-4.5 | N = 0.8C |
| >4.5 | Error |

and wherein when the INR target is from about 2.5 to about 3.5 and the series of equations is:

| INR | Equation |
|---|---|
| 1.0-1.6 | N = 1.2C |
| 1.7-1.9 | N = 1.15C |
| 2.0-2.4 | N = 1.1C |
| 2.5-3.5 | N = C |
| 3.6-3.8 | N = 0.95C |
| 3.9-4.1 | N = 0.9C |
| 4.2-4.3 | N = 0.8C |
| 4.4-4.5 | N = 0.75C |
| >4.5 | Error |

and wherein N is the new dose and C is the previous cumulative weekly dose.
